(19) United States
(12) Patent Application Publication
(10) Pub. No.: US 2026/0332937 A1
(43) Pub. Date: Oct. 22, 2026

(54) EARPHONES

(71) Applicant: SHENZHEN SHOKZ CO., LTD., Shenzhen (CN)

(72) Inventors: Lei ZHANG, Shenzhen (CN); Chaojie CUI, Shenzhen (CN); Lei ZHONG, Shenzhen (CN); Jiang XU, Shenzhen (CN); Weijie YUAN, Shenzhen (CN); Lei WANG, Shenzhen (CN)

(73) Assignee: SHENZHEN SHOKZ CO., LTD., Shenzhen (CN)

(21) Appl. No.: 19/704,347

(22) Filed: Jun. 10, 2026

Related U.S. Application Data
(63) Continuation of application No. PCT/CN2024/138269, filed on Dec. 10, 2024.

(30) Foreign Application Priority Data
Dec. 11, 2023 (CN) 202311701969.7
Feb. 6, 2024 (CN) 202410172377.9
Feb. 6, 2024 (WO) PCT/CN2024/076377
Feb. 6, 2024 (WO) PCT/CN2024/076378
Feb. 6, 2024 (WO) PCT/CN2024/076388
Feb. 6, 2024 (WO) PCT/CN2024/076389
Feb. 6, 2024 (WO) PCT/CN2024/076495

(51) Int. Cl. H04R 1/10; H04R 1/34

(52) U.S. Cl. CPC H04R 1/1075; H04R 1/1008; H04R 1/105; H04R 1/345; H04R 2460/11

(57) ABSTRACT

An earphone is provided. The earphone includes a sound generating component, an abutting component, and an ear hook. In a wearing state, the sound generating component forms a clamping state with the abutting component, and is located in a cavum concha. The sound generating component includes a sound generating assembly and a first housing provided with a sound outlet hole. The sound outlet hole is arranged in a strip shape and has a first end and a second end spaced apart along its length direction. In the wearing state, the first end is oriented toward an ear hole, and a distance between an outer wall surface of the first housing at the second end and an inner wall surface of the cavum concha is less than a distance between the outer wall surface of the first housing at the first end and the inner wall surface of the cavum concha.

### CROSS-REFERENCE TO RELATED APPLICATIONS

This application is a continuation of International Patent Application No. PCT/CN2024/138269, filed on Dec. 10, 2024, which claims the priority of Chinese Patent Application No. 202311701969.7, filed on Dec. 11, 2023, Chinese Patent Application No. 202410172377.9, filed on Feb. 6, 2024, International Patent Application No. PCT/CN2024/076495, filed on Feb. 6, 2024, International Patent Application No. PCT/CN2024/076377, filed on Feb. 6, 2024, International Patent Application No. PCT/CN2024/076378, filed on Feb. 6, 2024, International Patent Application No. PCT/CN2024/076388, filed on Feb. 6, 2024, and International Patent Application No. PCT/CN2024/076389, filed on Feb. 6, 2024, the contents of each of which are hereby incorporated by reference.

### TECHNICAL FIELD

The present disclosure generally relates to the field of electronic devices, and in particular to an earphone.

### BACKGROUND

Earphones are widely used in people's daily lives. Earphones can be used with electronic devices, such as mobile phones, computers, etc., to provide sound playback functions for users. Ear-clip earphones are a new type of earphone. Ear-clip earphones usually have a small volume and can be clipped to a user's helix for use. Furthermore, these ear-clip earphones do not block the ear canal. Ear-clip earphones not only ensure safety in outdoor scenarios but also provide better wearing comfort compared to in-ear earphones.

However, the sound quality of current ear-clip earphones is difficult to meet requirements.

### SUMMARY

One or more embodiments of the present disclosure provide an earphone. The earphone includes a sound generating component, an abutting component, and an ear hook. The ear hook connects the sound generating component and the abutting component. The sound generating component is configured to covert an electrical signal into an acoustic signal and play the acoustic signal, and a battery is disposed within the abutting component. In a wearing state, the sound generating component and the abutting component form a clamping state on two sides of a helix of a user, and the sound generating component is located in a concha cavity. The sound generating component includes a first housing and a sound generating assembly, and the first housing is configured to form a first accommodating cavity. The sound generating assembly is disposed in the first accommodating cavity. The first housing is provided with a sound outlet hole. A sound generated by the sound generating assembly is output through the sound outlet hole. The sound outlet hole is arranged in a strip shape and has a first end and a second end spaced apart along a length direction of the sound outlet hole. In the wearing state, the first end oriented toward an ear hole, and a distance between an outer wall surface of the first housing at the second end and an inner wall surface of the concha cavity is less than a distance between the outer wall surface of the first housing at the first end and the inner wall surface of the concha cavity.

In some embodiments, at the second end and/or on a side of the second end away from the first end, the outer wall surface of the first housing and the inner wall surface of the concha cavity are in contact with each other.

In some embodiments, the outer wall surface of the first housing is configured such that a long edge of the sound outlet hole is arranged in an arc shape. A distance between the outer wall surface of the first housing and the inner wall surface of the concha cavity gradually increases in a direction from the second end to the first end.

In some embodiments, an arc-to-chord ratio of the long edge of the sound outlet hole is in a range of 1.05-1.4, or is greater than or equal to 1.02 and less than 1.05.

In some embodiments, an aspect ratio of the sound outlet hole is in a range of 0.15-0.30.

In some embodiments, a length of the sound outlet hole is in a range of 9 mm-16.5 mm, or is greater than or equal to 5 mm and less than 9 mm.

In some embodiments, when the sound generating component and the abutting component are simultaneously placed on a horizontal reference plane, the long edge of the sound outlet hole forms a first reference point between the first end and the second end with the horizontal reference plane. The second end is located on a side of the first reference point toward the abutting component. The first end is located on a side of the first reference point away from the abutting component.

In some embodiments, a length of the long edge of the sound outlet hole between the first end and the first reference point is in a range of 2 mm-5.5 mm. A length of the long edge of the sound outlet hole between the second end and the first reference point is in a range of 4.5 mm-8 mm.

In some embodiments, an arc-to-chord ratio of the long edge of the sound outlet hole between the first end and the first reference point is in a range of 1.02-1.05, or is greater than or equal to 1.001 and less than 1.02. An arc-to-chord ratio of the long edge of the sound outlet hole between the second end and the first reference point is in a range of 1.02-1.05, or is greater than 1.05 and less than or equal to 1.07.

In some embodiments, the long edge of the sound outlet hole has a first normal direction at the first reference point, a second normal direction at the first end, and a third normal direction at the second end. An included angle between the first normal direction and the second normal direction is in a range of 30°-42°, or is greater than or equal to 15° and less than 30°. An included angle between the first normal direction and the third normal direction is in a range of 50°-60°, or is greater than or equal to 25° and less than 50°.

In some embodiments, the sound outlet hole has a median line along the length direction of the sound outlet hole. The sound outlet hole intersects with a reference cross-section along a length direction of the ear hook. An included angle between a plane where the median line lies and the reference cross-section is in a range of 0°-45°. The sound outlet hole is offset toward an earlobe direction.

In some embodiments, the plane where the median line lies and the reference cross-section coincide with each other; or the sound outlet hole is mirror-symmetric with respect to the reference cross-section.

In some embodiments, on the reference cross-section, the sound generating component has a second reference point closest to the abutting component. An inner contour of the ear hook has a third reference point farthest from the second reference point in a region close to an edge of the helix in the wearing state. The sound outlet hole is located on a side of the second reference point away from the third reference point. On an outer wall surface of the sound generating component, a distance from the second end to the second reference point is in a range of 2.2 mm-4.2 mm, and a distance from the first end to the second reference point is in a range of 9 mm-12.4 mm.

In some embodiments, the sound generating component is further provided with a pressure relief hole. The pressure relief hole is oriented toward the helix. The pressure relief hole intersects with the reference cross-section, or is mirror-symmetric with respect to the reference cross-section.

In some embodiments, the pressure relief hole and the sound outlet hole are spaced apart from each other by a contact region between the sound generating component and the concha cavity.

In some embodiments, a count of pressure relief holes is one, the pressure relief hole is arranged in a strip shape. The reference cross-section is arranged along a width direction of the pressure relief hole and intersects with the pressure relief hole.

In some embodiments, a count of pressure relief holes is two, which are respectively disposed on two sides of the reference cross-section and are mirror-symmetric with respect to the reference cross-section. The reference cross-section is disposed along a width direction of any of the two pressure relief holes.

In some embodiments, the pressure relief hole includes a first aperture part and a second aperture part along a length direction of the pressure relief hole, and a third aperture part connected between the first aperture part and the second aperture part. A width of at least a portion of the first aperture part and the second aperture part is greater than a width of the third aperture part.

In some embodiments, the sound generating assembly is provided with a sound guiding hole communicating with the pressure relief hole through the first accommodating cavity. A distance between the sound guiding hole and the pressure relief hole is not greater than 0.5 mm, or is greater than 0.5 mm and less than or equal to 4 mm.

In some embodiments, the earphone further includes a microphone. The first housing is provided with a sound inlet for guiding external sound to the microphone. The sound inlet intersects with the reference cross-section.

In some embodiments, the sound generating assembly includes two loudspeakers. Each of the two loudspeakers includes a diaphragm. The two loudspeakers are assembled with each other along an axial direction to form a first acoustic cavity between the two loudspeakers. The sound generating assembly is provided with a first sound guiding hole communicating the sound outlet hole and the first acoustic cavity. The sound outlet hole and the first sound guiding hole communicate with each other along a radial direction of the sound generating assembly. The first sound guiding hole is further arranged in a strip shape. A length direction of the sound outlet hole and a length direction of the first sound guiding hole are arranged along a circumferential direction of the sound generating assembly.

### BRIEF DESCRIPTION OF THE DRAWINGS

FIG. 1 is a schematic diagram of a wearing state of an earphone on a human ear according to some embodiments of the present disclosure;

FIG. 2 is a schematic diagram illustrating a front view of the structure of the earphone shown in FIG. 1 according to some embodiments of the present disclosure;

FIG. 3 is a schematic diagram illustrating a perspective view of the structure of the earphone shown in FIG. 1 according to some embodiments of the present disclosure;

FIG. 4 is a schematic diagram illustrating a top view of the structure of the earphone shown in FIG. 1 according to some embodiments of the present disclosure;

FIG. 5 is a schematic diagram illustrating a perspective view of the structure of a sound generating component of the earphone shown in FIG. 1 according to some embodiments of the present disclosure;

FIG. 6 is a schematic diagram illustrating a front view of the structure of the sound generating component shown in FIG. 5 according to some embodiments of the present disclosure;

FIG. 7 is a cross-sectional schematic diagram of the structure of the sound generating component shown in FIG. 6 along a section line A-A according to some embodiments of the present disclosure;

FIG. 8 is another cross-sectional schematic diagram of the structure of the sound generating component shown in FIG. 6 along a section line A-A according to some embodiments of the present disclosure;

FIG. 9 is a schematic diagram illustrating a top view of the structure of the sound generating component shown in FIG. 5 according to some embodiments of the present disclosure;

FIG. 10 is a schematic diagram illustrating a side view of the structure of a sound generating assembly of the sound generating component shown in FIG. 8 according to some embodiments of the present disclosure;

FIG. 11 is a cross-sectional schematic diagram of the structure of the sound generating assembly shown in FIG. 10 along a section line P-P according to some embodiments of the present disclosure;

FIG. 12 is an exploded schematic diagram of the sound generating assembly shown in FIG. 8 according to some embodiments of the present disclosure;

FIG. 13 is a schematic diagram illustrating a perspective view of another exemplary sound generating assembly of the sound generating component shown in FIG. 8 according to some embodiments of the present disclosure;

FIG. 14 is an enlarged schematic diagram of a local region Q of the sound generating assembly shown in FIG. 11 according to some embodiments of the present disclosure;

FIG. 15 is a schematic diagram illustrating a side view of the structure of the sound generating component shown in FIG. 5 according to some embodiments of the present disclosure;

FIG. 16 is a cross-sectional schematic diagram of the structure of the sound generating component shown in FIG. 15 along a section line J-J according to some embodiments of the present disclosure;

FIG. 17 is a schematic diagram illustrating a top view of the structure of the sound generating assembly of the sound generating component shown in FIG. 16 according to some embodiments of the present disclosure;

FIG. 18 is a schematic diagram illustrating another side view of the structure of the sound generating assembly of the sound generating component shown in FIG. 8 according to some embodiments of the present disclosure;

FIG. 19 is an exploded schematic diagram of the structure of the sound generating component shown in FIG. 5 according to some embodiments of the present disclosure;

FIG. 20 is another exploded schematic diagram of the structure of the sound generating component shown in FIG. 5 according to some embodiments of the present disclosure;

FIG. 21 is a cross-sectional schematic diagram of the structure of the sound generating component shown in FIG. 15 along a section line U-U according to some embodiments of the present disclosure;

FIG. 22 is another schematic diagram of the structure of a pressure relief hole of the sound generating component shown in FIG. 15 according to some embodiments of the present disclosure;

FIG. 23 is yet another exploded schematic diagram of the structure of the sound generating component shown in FIG. 5 according to some embodiments of the present disclosure;

FIG. 24 is a cross-sectional schematic diagram of the structure of the earphone shown in FIG. 4 along a section line V-V according to some embodiments of the present disclosure;

FIG. 25 is a schematic diagram of an outline of a cross-section corresponding to the section line V-V shown in FIG. 24 according to some embodiments of the present disclosure;

FIG. 26 is a schematic diagram illustrating a perspective view of the structure of the earphone shown in FIG. 1 in a state with a preload force according to some embodiments of the present disclosure;

FIG. 27 is a schematic diagram illustrating a change in a clamping force of the earphone shown in FIG. 26 according to some embodiments of the present disclosure;

FIG. 28 is a schematic diagram illustrating a structure for measuring the preload force of the earphone shown in FIG. 26 using a thin-film pressure sensor according to some embodiments of the present disclosure;

FIG. 29 is a schematic diagram illustrating the structure of a measurement device for a clamping force/preload force of the earphone shown in FIG. 26 according to some embodiments of the present disclosure;

FIG. 30 is another schematic diagram illustrating the structure of another measurement device for a clamping force/preload force of the earphone shown in FIG. 26 according to some embodiments of the present disclosure;

FIG. 31 is a schematic diagram illustrating the structure of the earphone shown in FIG. 1 having a magnetic coupling matching structure according to some embodiments of the present disclosure;

FIG. 32 is a schematic diagram illustrating a change in a clamping force of the earphone shown in FIG. 31 according to some embodiments of the present disclosure;

FIG. 33 is a schematic diagram illustrating a change in a clamping force of the earphone described in FIG. 31 in a state with a preload force according to some embodiments of the present disclosure;

FIG. 34 is a cross-sectional schematic diagram of the structure of the earphone shown in FIG. 2 along a section line I-I according to some embodiments of the present disclosure;

FIG. 35 is another schematic diagram of an outline of a cross-section corresponding to the section line V-V shown in FIG. 24 according to some embodiments of the present disclosure; and

FIG. 36 is another schematic diagram of the structure of the earphone shown in FIG. 1 according to some embodiments of the present disclosure.

### DETAILED DESCRIPTION

The present invention is further described in detail below through specific embodiments in conjunction with the accompanying drawings. Similar components in different embodiments are denoted by associated similar reference numerals. In the following embodiments, many details are described to facilitate a better understanding of the present application. However, those skilled in the art can readily recognize that some of these features may be omitted under different circumstances or may be replaced by other elements, materials, or methods. In some instances, certain operations related to the present application are not shown or described in the specification to avoid obscuring the core aspects of the present application. For those skilled in the art, a detailed description of these related operations is not necessary, as they can fully understand the associated operations based on the descriptions in the specification and general technical knowledge in the art.

Furthermore, the characteristics, operations, or features described in the specification can be combined in any suitable manner to form various embodiments. Meanwhile, the steps or actions in the method descriptions can also be rearranged or adjusted in a manner obvious to those skilled in the art. Therefore, the various sequences in the specification and drawings are only for clearly describing a particular embodiment and do not imply a mandatory sequence, unless otherwise specified that a specific sequence must be followed.

The serial numbers assigned to components herein, such as “first” and “second,” are used only to distinguish the described objects and carry no sequential or technical meaning. The terms “connect” and “couple” as used in the present application, unless otherwise specified, include both direct and indirect connection (coupling).

As shown in FIG. 1, an ear (EAR) of a user may include physiological parts such as an ear canal E11, a concha cavity E12, a cymba concha E13, a triangular fossa E14, an antihelix E15, a scapha E16, a helix E17, and an antitragus E18. Although the ear canal E11 has a certain depth and extends to an eardrum of the ear (EAR), for ease of description and in conjunction with FIG. 1, the ear canal E11 in the present disclosure, unless otherwise specified, specifically refers to an entrance (i.e., the earhole) of the ear canal facing away from the eardrum. Furthermore, physiological parts such as the concha cavity E12, the cymba concha E13, and the triangular fossa E14 have a certain volume and depth. The concha cavity E12 is directly connected to the ear canal E11, meaning the aforementioned earhole can simply be considered to be located at the bottom of the concha cavity E12.

Furthermore, the EAR has a tragus E19 around the periphery of the ear canal. Compared to parts such as the concha cavity E12, the cymba concha E13, and the triangular fossa E14, which have a certain depth and volume in three-dimensional space (i.e., the concha cavity E12, the cymba concha E13, and the triangular fossa E14 are recessed toward the rear side of the EAR along a direction toward the head of the user), the tragus E19 protrudes toward the front side of the EAR along a direction away from the head of the user. “The front side of the EAR” is a concept relative to “the rear side of the EAR”. The former (the front side of the EAR) refers to a side of the EAR facing away from the head, e.g., as shown in FIG. 1. The latter (the rear side of the EAR) refers to a side of the EAR facing toward the head. “The front side of the EAR” and “the rear side of the EAR” are defined with respect to the EAR of the user.

Furthermore, different users may have individual differences, resulting in variations in the shape, size, and other dimensions of the EAR. For ease of description and to reduce (or even eliminate) individual differences among different users, a simulator including a head and (left, right) ears (EAR) of the head may be manufactured based on ANSI: S3.36, S3.25, and IEC: 603187 standards, e.g., GRAS 45BC KEMAR. Therefore, descriptions such as “a user wears the earphone,” “the earphone is in a wearing state,” and “in the wearing state” may refer to the earphone described in the present disclosure being worn on the EAR of the aforementioned simulator. Certainly, precisely because different users have individual differences, there may be some variation when the earphone is worn by different users compared to when it is worn on the EAR of the aforementioned simulator. However, such variation should be tolerable.

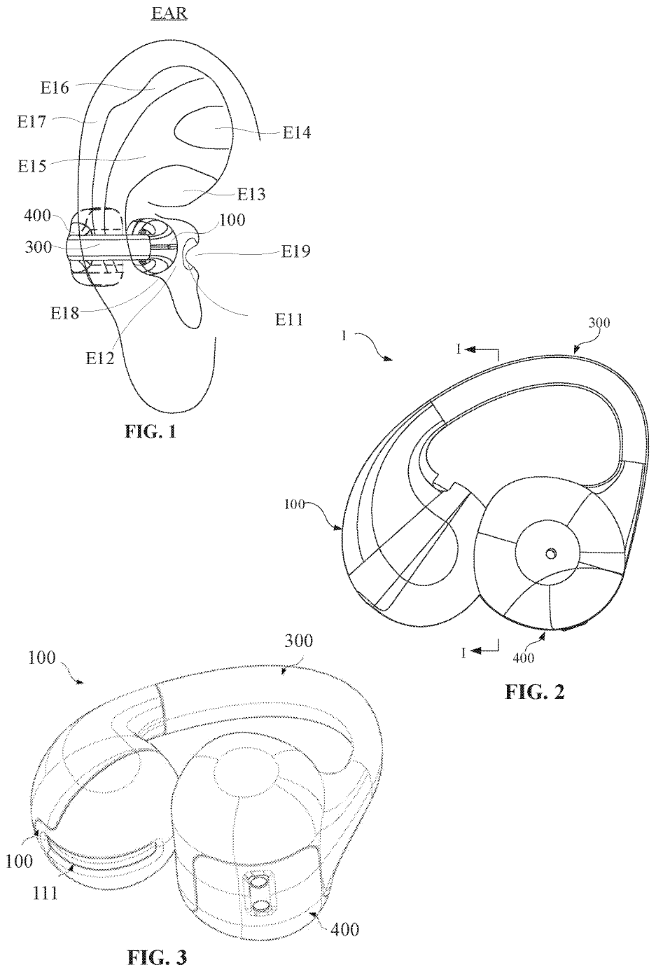

Embodiments of the present disclosure describe at least one exemplary structure of an earphone 1. As shown in FIG. 1, FIG. 1 illustrates a state where the earphone 1 is worn on an ear (EAR) of a user. The earphone 1 may be an ear-clip earphone. As shown in FIG. 1 to FIG. 4, the earphone 1 includes a sound generating component 100 for inserting into a concha cavity E12 of the user, an abutting component 400 for abutting behind the ear of the user, and an ear hook 300 connected to the sound generating component 100 and the abutting component 400. The ear hook 300 may bypass the user's helix E17. The sound generating component 100 and the abutting component 400 form a clamping state on two sides of the helix of the user. The sound generating component 100 is a sound playback device. The sound generating component is configured to convert an electrical signal into an acoustic signal and play the acoustic signal to the wearer. The abutting component 400 and the sound generating component 100 form the clamping state to clamp the entire earphone 1 onto the helix of the user for wearing. In some embodiments, components such as a battery and a circuit board may be disposed within the abutting component 400. Certainly, the abutting component 400 may also be used without a battery, and the battery may be installed in the sound generating component 100.

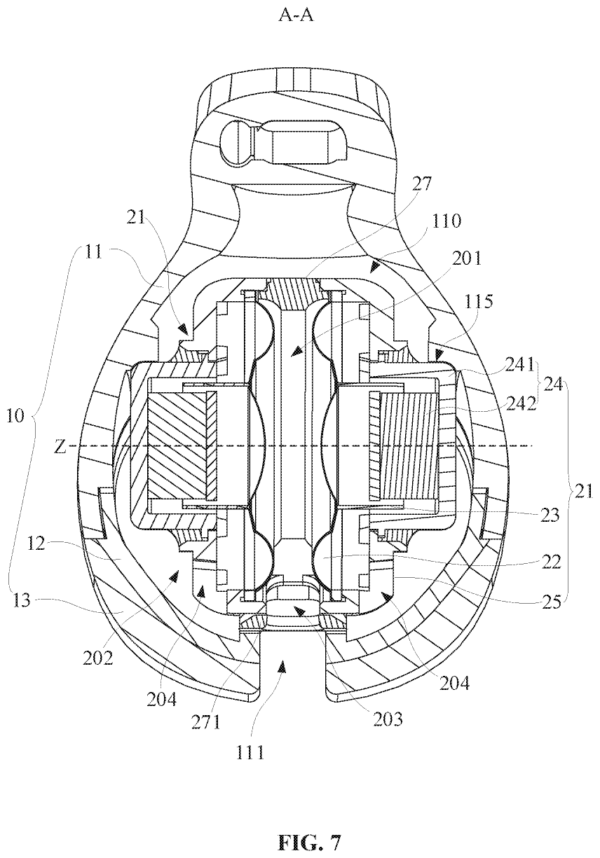

In some embodiments, as shown in FIG. 5 and FIG. 6, the sound generating component 100 may be provided with a sound outlet hole 111 and a pressure relief hole 112. The sound outlet hole 111 may be located at a bottom of the sound generating component 100. The pressure relief hole 112 may be located on a side of the sound generating component 100 close to the ear hook 300. As shown in FIG. 7, the sound generating component 100 includes a first housing 10 and a sound generating assembly 20. The first housing 10 is configured to form a first accommodating cavity 110. The sound generating assembly 20 is disposed in the first accommodating cavity 110.

As shown in FIG. 7, the sound generating assembly 20 includes two speakers 21. Each of the two speakers 21 includes a diaphragm 22. The two speakers 21 are assembled and cooperated with each other along an axial direction (i.e., a direction of the axis Z) to form a first acoustic cavity 201 between the two speakers 21. The sound generating assembly 20 and the first housing 10 cooperate with each other to form a second acoustic cavity 202 between the sound generating assembly 20 and the first housing 10. The second acoustic cavity 202 is isolated from the first acoustic cavity 201. The first housing 10 is provided with the sound outlet hole 111 communicating with the first acoustic cavity 201 and the pressure relief hole 112 communicating with the second acoustic cavity 202. A sound generated by one side of the diaphragm 22 of each of the two speakers 21 is output through the first acoustic cavity 201 and the sound outlet hole 111. A sound generated by another side of the diaphragm 22 of each of the two speakers 21 is output through the second acoustic cavity 202 and the pressure relief hole 112. The axial direction may be a direction indicated by a central axis Z of the sound generating assembly 20. The central axis Z may, for example, pass through a geometric center of the sound generating assembly 20 and the geometric centers of the diaphragms 22 of the two speakers 21. The central axis Z may also be a central axis of magnetic circuits of the two speakers 21.

For the speaker 21 used to generate sound, a sound pressure level (SPL) is an important parameter for measuring the performance of the speaker 21. The sound pressure level is commonly used to compare pressure levels emitted by different sound sources, serving to quantify and compare sound intensity. Sound pressure level is a measure used to describe the magnitude of sound, which represents the logarithm of a ratio of an effective value of the sound pressure to its reference value. The specific formula (1) is as follows:

$$SPL = 20 \times {log}_{10} \frac{P}{Pref} , \qquad ( 1 )$$

where SPL denotes the sound pressure level, P denotes a sound pressure generated by the speaker 21 during operation, and Pref denotes a reference sound pressure. When the sound generating assembly 20 is provided with only a single speaker 21, the sound pressure generated during the operation of the speaker 21 is P. However, under the same conditions, when two speakers 21 are provided in the sound generating assembly 20, the sound pressure generated during the operation of the two speakers 21 is 2P. According to the above formula, a difference in sound pressure level between the single speaker 21 and the two speakers 21 is calculated as follows:

$$Δ = 20 \times {log}_{10} \frac{2 P}{P} \approx 6 dB . \qquad ( 2 )$$

From the above derivation, it should be seen that, compared to providing only one speaker 21, assembling and cooperating two speakers 21 along the axial direction (i.e., the direction of the axis Z) within the sound generating assembly 20 and forming the first acoustic cavity 201 between the two speakers for sound output can effectively increase the sound pressure level of the sound generating assembly 20, thereby achieving a better volume effect, allowing the user to hear clearer sound, and effectively improving the sound quality of the earphone 1.

Furthermore, through the assembly and cooperation of the two speakers 21, the diaphragms 22 of the two speakers 21 may face each other to form the first acoustic cavity 201. The first acoustic cavity 201 is a space where the diaphragms 22 vibrate to push air, generating sound waves for the user to listen to. The second acoustic cavity 202 is in communication with the pressure relief hole 112 to connect to the outside environment, and is used to balance the air pressure inside the first housing 10. The first acoustic cavity 201 may be formed simply by assembling and cooperating the two speakers 21. The two speakers 21, after being assembled together, are then assembled as a whole into the first housing 10. This simplifies the structure and facilitates assembly. Moreover, by utilizing the space between the sound generating assembly 20 and the first housing 10 to form the second acoustic cavity 202, which is isolated from the first acoustic cavity 201, there is no need for additional structures or components to form the second acoustic cavity 202. This also simplifies the structure, reduces the assembly difficulty of the earphone 1, and improves the assembly efficiency of the earphone 1.

Optionally, the two speakers 21 of the sound generating assembly 20 have the same acoustic characteristics and are coaxially arranged along the axial direction (i.e., the direction of the axis Z). The same acoustic characteristics of the two speakers 21 means that when driven by the same driving signal, the sound pressures generated by the two speakers 21 are the same or similar. Specifically, a ratio of a difference in the sound pressures of the two speakers 21 to a minimum sound pressure is not greater than 10%. By providing two speakers 21 with the same acoustic characteristics and coaxially disposing them along the axial direction (i.e., the direction of the axis Z), the sound quality of the sound generating assembly 20 is improved.

Optionally, as shown in FIG. 7, the sound generating assembly 20 further includes a mounting bracket 27. The mounting bracket 27 may be provided in an annular shape. The two speakers 21 are respectively assembled and cooperated with two ends of the mounting bracket 27 to form the first acoustic cavity 201. The mounting bracket 27 is provided with a first sound guiding hole 23 through which the sound outlet hole 111 and the first acoustic cavity 201 are in communication with each other

By providing the annular mounting bracket 27, the first acoustic cavity 201 is formed while achieving the assembly of the two speakers 21. The first sound guiding hole 203 is provided on the mounting bracket 27 to achieve communication between the sound outlet hole 111 and the first acoustic cavity 201. Thus, sound waves in the first acoustic cavity 201 are transmitted sequentially through the first sound guiding hole 203 and the sound outlet hole 111 to the EAR of the user. The structure is effectively simplified. The structural compactness and integration of the sound generating assembly 20 are effectively improved. This is conducive to reducing assembly difficulty and improving assembly efficiency.

Optionally, in some embodiments, as shown in FIG. 7, each of the two speakers 21 includes a voice coil 23, a magnetic circuit system 24, and a frame 25. The frame 25 is configured to support the diaphragm 22 and the magnetic circuit system 24. The voice coil 23 is connected to the diaphragm 22 and provided within a magnetic field formed by the magnetic circuit system 24. The frames 25 of the two speakers 21 are assembled and cooperated with the mounting bracket 27, such that the first acoustic cavity 201 is formed between the diaphragms 22 of the two speakers 21 and the mounting bracket 27. The voice coil 23 may be cylindrical. An axis of the voice coil 23 may be the central axis Z of the sound generating assembly 20. The voice coil 23 moves along the axial direction (i.e., the direction of the axis Z) under the action of the magnetic field formed by the magnetic circuit system 24, so as to drive the diaphragm 22 to vibrate and generate the sound waves.

By assembling the frames 25 of the two speakers 21 with the mounting bracket 27 to achieve assembly of the sound generating assembly 20, and by configuring the frame 25 to support the diaphragm 22 and the magnetic circuit system 24, the structure is simple and compact. The assembly difficulty is effectively reduced. The assembly efficiency is effectively improved.

FIG. 7 shows the assembly of the frames 25 of the two speakers 21 with the mounting bracket 27. Optionally, in some embodiments, the mounting bracket 27 may be omitted. The frames 25 of the two speakers 21 may be assembled and cooperated with each other to form the first acoustic cavity 201. In this case, the frame 25 of at least one of the two speakers 21 is provided with the first sound guiding hole 203 through which the sound outlet hole 111 and the first acoustic cavity 201 are in communication with each other. For example, both two frames 25 may be provided with the sound outlet hole 111, or each of the two frames 25 may be provided with a portion of the sound outlet hole 111, which forms a complete sound outlet hole 111 after assembly. By assembling the two frames 25 with each other, the assembly of the two speakers 21 and the formation of the first acoustic cavity 201 are achieved. No additional connecting component is needed. This simplifies the structure and reduces production costs. It is conducive to reducing assembly difficulty and improving assembly efficiency.

Optionally, as shown in FIG. 7, the diaphragms of the two speakers are disposed adjacent to each other, and the diaphragm of each of the two speakers is disposed on one side away from the magnetic circuit system corresponding to the speaker. The first acoustic cavity is formed between the diaphragms of the two speakers

The diaphragms 22 of the two speakers 21 are driven to vibrate by their respective voice coils 23, to generate sound waves for user's listening on the sides away from their respective magnetic circuit systems 24. By disposing the diaphragms 22 of the two speakers 21 adjacent to each other on the side away from their respective magnetic circuit systems 24, both speakers 21 generate sound waves within the first acoustic cavity 201. This effectively simplifies the structure of the sound generating assembly 20. It also facilitates reducing the volume of the first acoustic cavity 201, making the structure of the sound generating assembly 20 more compact. This is conducive to reducing the volume of the earphone 1 and improving the wearing comfort of the earphone 1. Furthermore, sharing the first acoustic cavity 201 by the two speakers 21 can also shift a resonant peak of the first acoustic cavity 201 towards a higher frequency, which is beneficial for improving the sound quality of the earphone 1.

As shown in FIG. 7, a second sound guiding hole 204 may be provided in each of the frames 25 of the two speakers 21. The second sound guiding hole 204 may communicate a side of the diaphragm 22 corresponding to the second sound guiding hole 204 and facing toward the magnetic circuit system 24 with the second acoustic cavity 202.

The side of the diaphragm 22 of each of the two speakers 21 facing the respective magnetic circuit system 24 communicates with the second acoustic cavity 202 through the second sound guiding hole 204 to communicate with the outside through the pressure relief hole 112, thereby balancing the air pressure inside the first housing 10. This ensures sound quality while simplifying the structure of the sound generating assembly 20 and facilitating assembly.

Optionally, in some embodiments, as shown in FIG. 7, the sides of the diaphragms 22 of the two speakers 21 facing their respective magnetic circuit systems 24 share the second acoustic cavity 202 and the pressure relief hole 112. Such a configuration can reduce a count of pressure relief holes 112, improving the aesthetics of the earphone 1. It also helps ensure consistency in the acoustic characteristics of the two speakers 21, which is beneficial for improving the sound quality of the sound generating assembly 20. Furthermore, sharing the second acoustic cavity 202 by the two speakers 21 also facilitates sealing and can reduce the volume of the first housing 10. This makes the structure of the earphone 1 more compact, effectively reduces the volume of the earphone 1, and is conducive to improving the wearing comfort of the earphone 1.

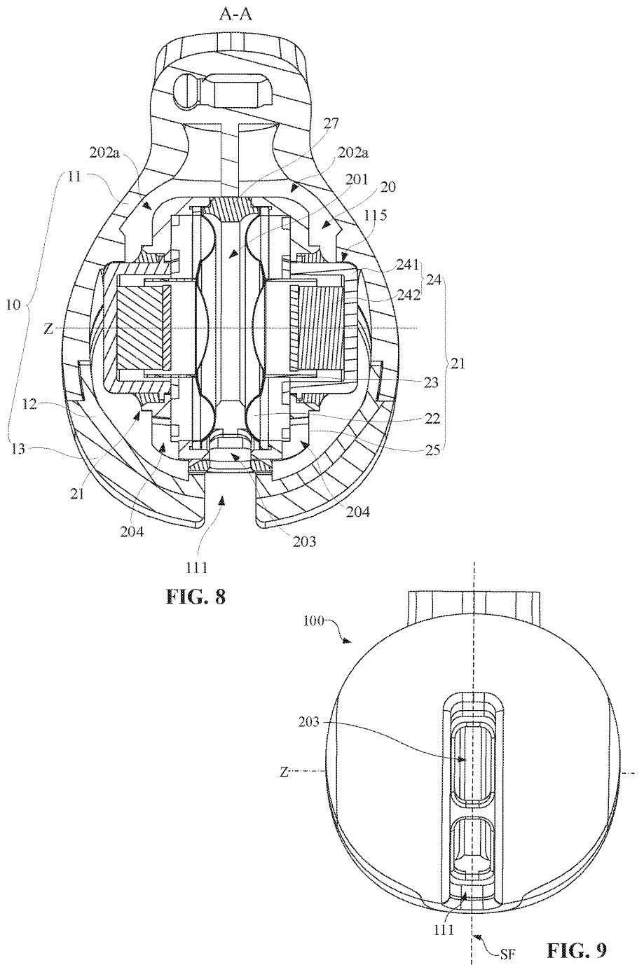

Optionally, in other embodiments, as shown in FIG. 8, the second acoustic cavity 202 includes two sub-acoustic cavities 202a isolated from each other. The first housing 10 is provided with pressure relief holes 112, respectively communicating with each of the two sub-acoustic cavities 202a. The sides of the diaphragms 22 of the two speakers 21 facing their respective magnetic circuit systems 24 may be respectively in communication with the corresponding sub-acoustic cavity 202a and pressure relief hole 112. By isolating the two sub-acoustic cavities 202a, the sound signals of the two speakers 21 can be made not completely identical, i.e., the earphone 1 can have a certain frequency division function, to adapt to different listening environments and sound quality requirements. Furthermore, the isolated sub-acoustic cavities 202a can reduce mutual interference between the two speakers 21, thereby improving the effectiveness and reliability of the operation of the two speakers 21, which is beneficial for improving the sound quality of the earphone 1.

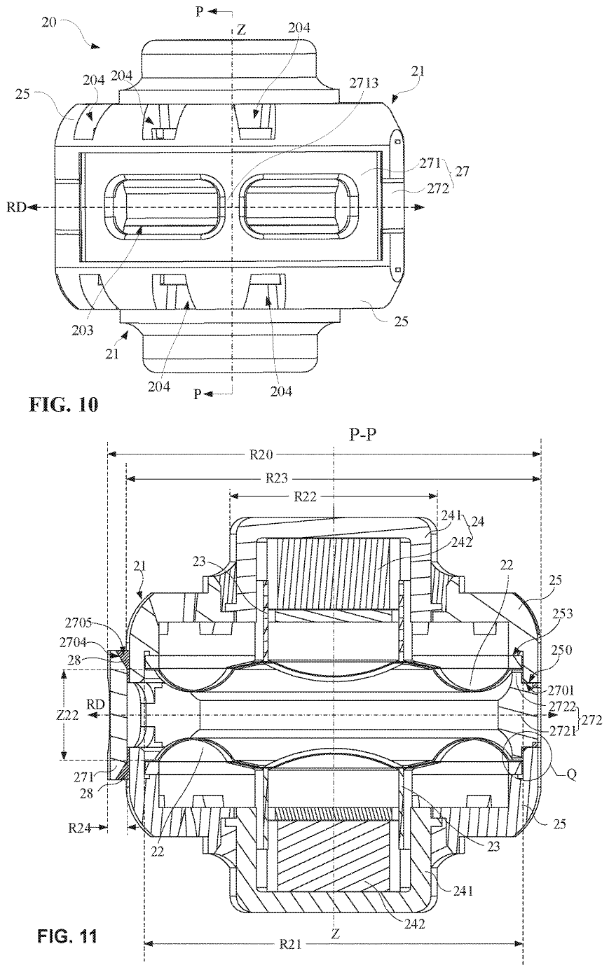

Optionally, as shown in FIG. 9 and FIG. 10, the sound outlet hole 111 and the first sound guiding hole 203 communicate with each other along a radial direction RD of the sound generating assembly 20. Each of the sound outlet hole 111 and the first sound guiding hole 203 is arranged in a strip shape. A length direction of the sound outlet hole 111 and a length direction of the first sound guiding hole 203 are arranged along a circumferential direction of the sound generating assembly. The radial direction RD of the sound generating assembly 20 is a direction perpendicular to the axial direction (i.e., the direction of the axis Z). The circumferential direction of the sound generating assembly 20 is a direction around the axial direction (i.e., the direction of the axis Z).

By configuring the sound outlet hole 111 and the first sound guiding hole 203 in a strip shape and arranging their length directions along the circumferential direction of the sound generating assembly 20, the area of the sound outlet hole 111 and the area of the first sound guiding hole 203 are ensured while reducing their length in the axial direction (i.e., the direction of the axis Z). This improves the structural compactness of the sound generating assembly 20, reduces the volume of the earphone 1, and improves the wearing comfort of the earphone 1.

In the present disclosure, descriptions relating to a certain physical/mathematical quantity (such as distance, ratio, area, length, width, thickness, etc.) falling within a certain numerical range may include the endpoint values of the numerical range. For example, if a distance is between A and B, the value of the distance may be A, may be B, or may be a value between A and B. Therefore, subsequent descriptions involving “between” numerical ranges are to be understood and applied according to the above explanation.

Optionally, as shown in FIG. 11, a spacing distance Z22 between mounting edges of the diaphragms 22 of the two speakers 21 along the axial direction (i.e., the direction of the axis Z) may be in a range of 1.6 mm to 2.5 mm. For example, the spacing distance Z22 may be 1.7 mm, 1.9 mm, 2.1 mm, 2.3 mm, etc. The spacing distance Z22 may also be other values. The mounting edge of the diaphragm 22 refers to the edge mounted on the frame 25. A radial dimension R21 of the first acoustic cavity 201 may be in a range of 7.5 mm to 9.5 mm. For example, the radial dimension R21 may be 7.8 mm, 8.1 mm, 8.5 mm, 8.8 mm, 9.1 mm, etc. The radial dimension R21 may also be other values. Optionally, an area of the sound outlet hole 111 and an area of the first sound guiding hole 203 may be in a range of 5 mm² to 18 mm², respectively. Optionally, the area of the sound outlet hole 111 and the area of the first sound guiding hole 203 may be in a range of 9 mm² to 20 mm², respectively. For example, the area of the sound outlet hole 111 and the area of the first sound guiding hole 203 may be 6 mm², 8 mm², 9 mm², 10 mm², 12 mm², 14 mm², 17 mm², 19 mm², etc. The area of the sound outlet hole 111 and the area of the first sound guiding hole 203 may also be other values. By reasonably setting the above dimensions, the structural compactness of the sound generating assembly 20 can be improved while shifting the resonant peak of the first acoustic cavity 201 towards a higher frequency, which is beneficial for improving the sound quality of the earphone 1.

Optionally, as shown in FIG. 11, one end of the magnetic circuit system 24 away from the corresponding diaphragm 22 may be provided protruding from the frame 25. A radial dimension R22 of a protruding portion of the magnetic circuit system 24 relative to the frame 25 is less than a radial dimension R23 of a support position where the frame 25 supports the diaphragm 22. This arrangement makes an outer contour of the sound generating assembly 20 closer to spherical, which facilitates improving structural compactness and integration, and effectively reduces the volume of the sound generating assembly 20. The first accommodating cavity 110 may be configured to be approximately spherical to match the appearance of the earphone 1. Thus, configuring the sound generating assembly 20 in this way facilitates its assembly into the first accommodating cavity 110, effectively improves the space utilization of the first accommodating cavity 110, and effectively improves the assembly efficiency of the earphone 1. Furthermore, by making the outer contour of the sound generating assembly 20 closer to spherical, it better adapts to the shape of the concha cavity E12, thereby fully utilizing the space within the concha cavity E12 and effectively improving the space utilization within the concha cavity E12.

Optionally, as shown in FIG. 11, a ratio of an axial dimension Z21 of the sound generating assembly 20 to the radial dimension R23 of the support position where the frame 25 supports the diaphragm 22 may be in a range of 0.8 to 1.3. For example, the ratio may be 0.9, 1, 1.1, etc. Optionally, a ratio of a maximum axial dimension Z21 of the sound generating assembly 20 to a maximum radial dimension R20 of the sound generating assembly 20 may be in a range of 0.8 to 1.3. The ratio may be 0.9, 1, 1.1, etc. Thus, the axial dimension Z21 of the sound generating assembly 20 and the radial dimension R23 of the support position where the frame 25 supports the diaphragm 22 are very close, making the outer contour of the sound generating assembly 20 closer to spherical. This facilitates better cooperation with the approximately spherical first accommodating cavity 110, effectively improves the space utilization of the first accommodating cavity 110, and effectively reduces assembly difficulty and improves assembly efficiency. For example, if the axial dimension Z21 of the sound generating assembly 20 is 9.5 mm and the radial dimension R23 of the support position where the frame 25 supports the diaphragm 22 is 8.1 mm, the ratio between them is approximately 1.17. As another example, if the axial dimension Z21 of the sound generating assembly 20 is 9.5 mm and the radial dimension R23 of the support position where the frame 25 supports the diaphragm is 8.8 mm, the ratio between them is approximately 1.08.

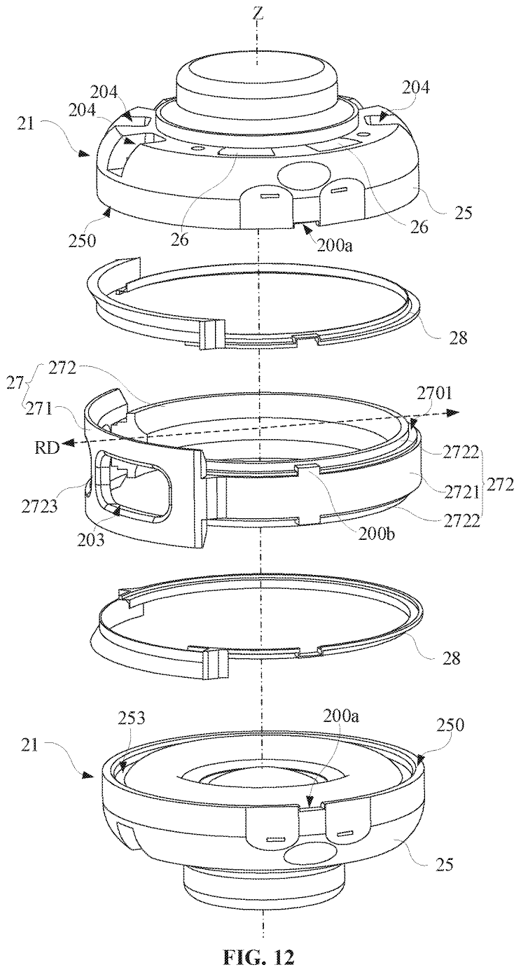

Optionally, in some embodiments, as shown in FIG. 11 and FIG. 12, the sound generating assembly 20 is provided with a mounting boss 271. The first sound guiding hole 203 is provided on the mounting boss 271. The mounting boss 271 abuts against the first housing 10 at a periphery of the sound outlet hole 111 (as shown in FIG. 7) to isolate the first sound guiding hole 203 and the sound outlet hole 111 from the second acoustic cavity 202. Certainly, in other embodiments, the mounting boss 271 may also be provided on the first housing 10, instead of on the sound generating assembly 20. Specifically, the first housing 10 is provided with the mounting boss 271. The sound outlet hole 111 is provided on the mounting boss 271. The mounting boss 271 abuts against the sound generating assembly 20 at a periphery of the first sound guiding hole 203 to isolate the first sound guiding hole 203 and the sound outlet hole 111 from the second acoustic cavity 202.

By providing the mounting boss 271, the connection between the first housing 10 and the sound generating assembly 20 is achieved while isolating the first sound guiding hole 203 and the sound outlet hole 111 from the second acoustic cavity 202. This simplifies the structure and improves the isolation effect. It avoids the output sound from the first sound guiding hole 203 and the output sound from the sound outlet hole 111 being affected by the pressure relief of the second acoustic cavity 202 through the pressure relief hole 112, thereby improving the sound quality of the earphone 1.

Optionally, as shown in FIG. 11 and FIG. 12, the sound generating assembly 20 further includes the mounting bracket 27. The mounting boss 271 may be disposed on the mounting bracket 27. The mounting bracket 27 further includes a bracket body 272 connected to the mounting boss 271 along the circumferential direction of the sound generating assembly 20 and disposed in a defective annular shape. The bracket body 272 may be provided with two first support platforms 2701 that are opposite to each other along the axial direction (i.e., the direction of the axis Z). An outer end surface 250 of the frame 25 proximate to a side of the corresponding diaphragm 22 may be supported on the corresponding first support platform 2701. The mounting boss 271 may protrude from the bracket body 272 along the axial direction (i.e., the direction of the axis Z) and the radial direction RD of the sound generating assembly 20, respectively, and is disposed at outer sides of outer peripheral surfaces of the two frames 25. With such an arrangement, the structural strength of the mounting boss 271 can be ensured while reserving sufficient space for the mounting boss 271 to arrange the first sound guiding hole 203. Furthermore, supporting two frames 25 on corresponding first support platforms 2701 can enhance structural stability, thereby effectively improving overall structural stability and reliability of the sound generating assembly 20.

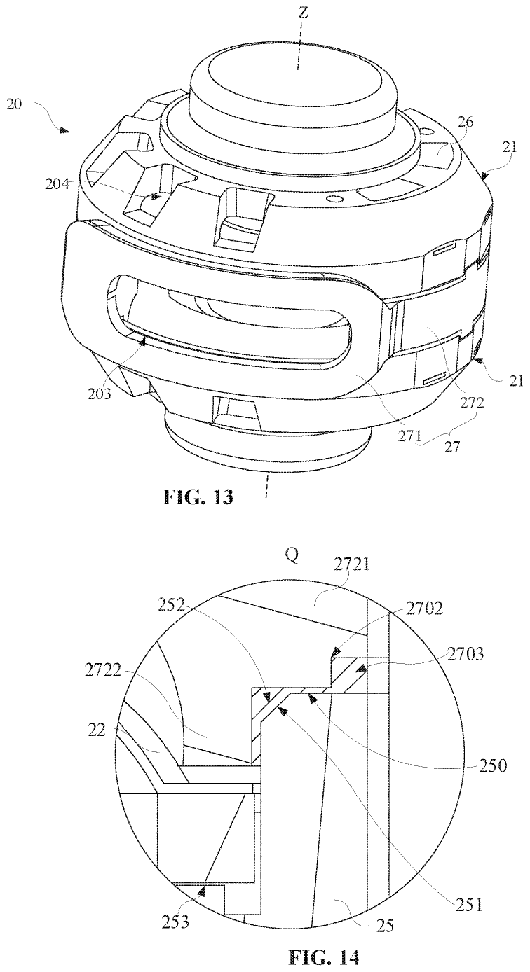

Optionally, as shown in FIG. 10 and FIG. 12, the mounting bracket 27 may be a plastic molded member, and a radial thickness R24 of the mounting boss 271 is in a range of 0.2 mm to 0.7 mm. Optionally, the radial thickness R24 of the mounting boss 271 may be 0.3 mm, 0.4 mm, 0.5 mm, 0.6 mm, etc. Of course, the radial thickness R24 may also be other values. The mounting boss 271 includes a connecting bridge 2723 arranged along a width direction of the first sound guiding hole 203 and connected to long edges 111c of the first sound guiding hole 203. The first sound guiding hole 203 is separated by the connecting bridge 2723 into at least two first sub-sound guiding holes spaced apart from each other along a length direction of the first sound guiding hole 203. The mounting bracket 27 may be, for example, injection molded, compression molded, etc. Of course, the mounting bracket 27 may also be made by other molding manners. Certainly, in other embodiments, as shown in FIG. 13, the mounting boss 271 may not be provided with the connecting bridge 2723, thereby obtaining the first sound guiding hole 203 with a larger area. Compared to the example shown in FIG. 12, a circumferential dimension of the first sound guiding hole 203 in FIG. 13 may be appropriately reduced to maintain structural strength. However, since the connecting bridge 2723 is eliminated, the area of the first sound guiding hole 203 can still be increased, thereby improving the sound quality.

By reasonably setting the radial thickness R24 of the mounting boss 271, space for the first sound guiding hole 203 is ensured without excessively increasing a radial dimension R20 of the sound generating assembly 20, thereby achieving a compact overall size of the earphone 1. Providing the connecting bridge 2723 facilitates molding of the mounting bracket 27 and effectively improves the connection strength of the mounting boss 271, thereby effectively enhancing the effectiveness and reliability of the sound generating assembly 20 during operation.

Optionally, in some embodiments, as shown in FIG. 11 and FIG. 12, the bracket body 272 includes a support portion 2721 and a limiting portion 2722. The limiting portion 2722 is connected to the support portion 2721. The first support platform 2701 is disposed on the support portion 2721. The limiting portion 2722 protrudes from the first support platform 2701 along the axial direction (i.e., the direction of the axis Z) and is embedded in the frame 25 to limit the frame 25 along the radial direction RD of the sound generating assembly 20.

Certainly, in other embodiments, the bracket body 272 may be provided with a recessed portion (not shown in the figures). From another perspective, the limiting portion 2722 is not convex but is concave, thereby forming the recessed portion. A portion of the frame 25 is embedded in the recessed portion to limit the frame 25 along the radial direction RD of the sound generating assembly 20.

By providing the limiting portion 2722 or the recessed portion to limit the frame 25 along the radial direction RD of the sound generating assembly 20, the structure is simple and stable, facilitating assembly and disassembly. This effectively improves structural stability of the sound generating assembly 20 while enhancing assembly efficiency.

Optionally, as shown in FIG. 11 and FIG. 12, a sealant 28 may be provided between the outer end surfaces 250 of the two frames 25 and the first support platform 2701, and between an inner peripheral surface of the mounting boss 271 and outer peripheral surfaces of the two frames 25, respectively. Disposing the sealant 28 at the aforementioned positions can effectively improve the isolation of the first acoustic cavity 201, thereby enhancing the sound quality of the earphone 1. Furthermore, the sealant 28 has good elasticity. During the assembly connection between the mounting boss 271 and the first housing 10, the sealant 28 can undergo a certain elastic deformation to make them fit more closely, thereby improving stability and sealing of the connection between the mounting boss 271 and the first housing 10, which is beneficial for improving the sound quality of the earphone 1.

Optionally, as shown in FIG. 11 and FIG. 14, the frame 25 may be provided with a first cut angle 251 at a corner proximate to a location where an outer peripheral surface of the limiting portion 2722 is connected to the first support platform 2701, thereby forming a first adhesive accommodating groove 252. The support portion 2721 may be provided with a second cut angle 2702 at a corner proximate to a position where the outer end surface 250 of the frame 25 is connected to the outer peripheral surface of the frame 25, thereby forming a second adhesive accommodating groove 2703.

By providing the first cut angle 251 and the second cut angle 2702 to form the first adhesive accommodating groove 252 and the second adhesive accommodating groove 2703, the capacity for accommodating the sealant 28 is effectively increased. This enhances sealing and isolation effects while effectively reducing adhesive overflow, thereby effectively reducing the possibility of interference with other components and helping to reduce assembly difficulty.

Optionally, as shown in FIG. 11, the mounting boss 271 is provided with a third cut angle 2704 at a corner proximate to the outer peripheral surface of the frame 25, thereby forming a third adhesive accommodating groove 2705. Providing the third cut angle 2704 can further increase the adhesive capacity and the isolation effect of the first acoustic cavity 201. Optionally, the second cut angle 2702 and the third cut angle 2704 are connected to each other, so that the second adhesive accommodating groove 2703 formed by the second cut angle 2702 and the third adhesive accommodating groove 2705 formed by the third cut angle 2705 can communicate with each other. Consequently, the adhesive application can be performed continuously during the coating process, effectively simplifying the process and improving assembly efficiency.

Optionally, as shown in FIG. 11 and FIG. 14, the frame 25 is further provided with a second support platform 253. The second support platform 253 is disposed on an inner side of the outer end surface 250 of the frame 25 along the radial direction RD of the sound generating assembly 20. The second support platform 253 is spaced apart from the outer end surface 250 of the frame 25 in the axial direction (i.e., the direction of the axis Z). A mounting edge of the diaphragm 22 is supported on the second support platform 253. A projection of the limiting portion 2722 at least partially falls on the second support platform 253 along the axial direction (i.e., the direction of the axis Z).

By providing the second support platform 253 to support the diaphragm 22, and locating the second support platform 253 on an inner side of the outer end surface 250 of the frame 25 along the radial direction RD of the sound generating assembly 20, the connection stability of the diaphragm 22 is improved, thereby enhancing the reliability of the diaphragm 22 during operation. Furthermore, configuring the projection of the limiting portion 2722 to at least partially fall on the second support platform 253 along the axial direction (i.e., the direction of the axis Z) achieves rational use of space and improves space utilization, which ensures the connection stability, while being beneficial for increasing the dimension of the first acoustic cavity 201 in the radial direction RD of the sound generating assembly 20, thereby helping to improve sound quality of the earphone 1.

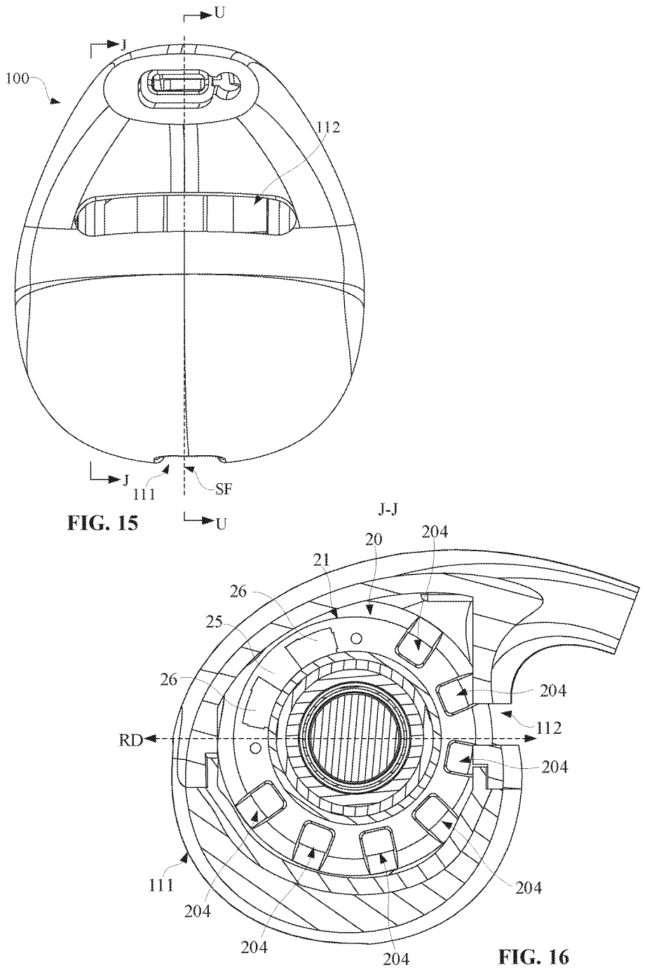

Optionally, as shown in FIG. 15 to FIG. 17, a plurality of second sound guiding holes 204 are provided. The plurality of second sound guiding holes are spaced apart along a circumferential direction of the sound generating assembly 20. The frame 25 is provided with a pad 26 disposed between two of the plurality of second sound guiding holes 204. A distance from a part of the plurality of the second sound guiding holes 204 to the pressure relief hole 112 is less than a distance from the pad 26 to the pressure relief hole 112. The pad 26 is configured to receive electrical signals to cause the speaker 21 to perform corresponding work. By arranging the plurality of second sound guiding holes 204 along the circumferential direction of the sound generating assembly 20, an acoustic path of sound output from the pressure relief hole 112 can be shortened. This is beneficial for improving the utilization of the volume of the second acoustic cavity 202, enhancing pressure relief efficiency, and improving the sound quality of the earphone 1. A section corresponding to a section line U-U in FIG. 15 is a reference cross-section SF.

Optionally, the distance from the part of the plurality of second sound guiding holes 204 to the pressure relief hole 112 is not greater than 0.5 mm. Further, optionally, the distance from the part of the plurality of second sound guiding holes 204 to the pressure relief hole 112 is not greater than 0.3 mm. If the distance from the second sound guiding hole 204 to the pressure relief hole 112 is too large, the pressure relief performance may decrease, thereby affecting the sound quality of the earphone 1. By reasonably setting the distance from the part of the plurality of second sound guiding holes 204 to the pressure relief hole 112, the pressure relief efficiency is effectively improved, which is beneficial for enhancing the sound quality of the earphone 1.

Optionally, as shown in FIG. 16, the second sound guiding hole 204 closest to the pressure relief hole 112 may be disposed opposite to the pad 26 along the radial direction RD of the sound generating assembly 20. Such an arrangement allows the operation of the pad 26 and the pressure relief operation of the earphone 1 to not interfere with each other, which is beneficial for improving the pressure relief performance of the earphone 1 and enhancing its sound quality.

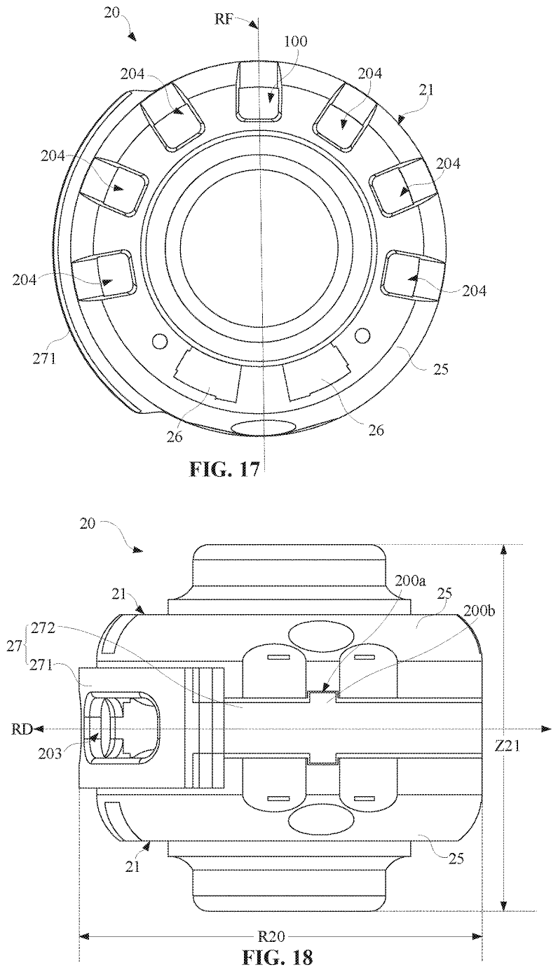

As shown in FIG. 16 and FIG. 17, specifically, the two frames 25 are respectively provided with pads 26 and second sound guiding holes 204 spaced apart from each other along a circumferential direction of the sound generating assembly 20. As shown in FIG. 12 and FIG. 18, each frame 25 and the mounting bracket 27 are provided with limiting structures 200a and 200b cooperating with each other. The limiting structures 200a and 200b are configured to limit the frame 25 and the mounting bracket 27 along the circumferential direction of the sound generating assembly 20. The limiting structures 200a and 200b of the two frames 25 are disposed opposite to each other along the axial direction (i.e., the direction of the axis Z). Optionally, as shown in FIG. 17 and FIG. 18, the sound generating assembly 20 has a radial plane RF disposed along the axial direction (i.e., the direction of the axis Z) and passing through the limiting structures 200a and 200b. The pads 26 on the frames 25 are mirrored with respect to the radial plane RF. The sound guiding holes on the frames 25 are mirror-symmetric with respect to the radial plane RF.

Using the limiting structures 200a and 200b to achieve the limitation of the two frames 25 along the circumferential direction of the sound generating assembly 20 prevents the relative rotation between the two speakers 21, effectively improving the structural stability and reliability of the sound generating assembly 20. Meanwhile, by arranging the pads 26 and the second sound guiding holes 204 on the frames 25 to be mirrored with respect to the radial plane RF, respectively, the directivity of the pads 26 and the second sound guiding holes 204 on the two frames 25 is made consistent. This improves consistency of acoustic characteristics of the two speakers 21 within the first accommodating cavity 110, which is beneficial for improving the sound quality of the earphone 1. Furthermore, by designing the structures of the two frames 25 with high consistency, the two speakers 21 can share the same frame 25 design, effectively reducing material costs and production costs.

Optionally, only one set of the limiting structures 200a and 200b is provided. Such a configuration makes the frames 25 to be mirror-symmetric with respect to the radial plane RF. The sides of the two frames 25 provided with the limiting structures 200a are installed facing each other. Consequently, the pads 26 on the frames 25 are also disposed opposite to each other and located on the same side of the sound generating assembly 20. This further ensures the directional consistency of the pads 26 on the two speakers 21, thereby improving the consistency of the acoustic characteristics of the two speakers 21 within the first accommodating cavity 110, which is beneficial for improving the sound quality of the earphone 1.

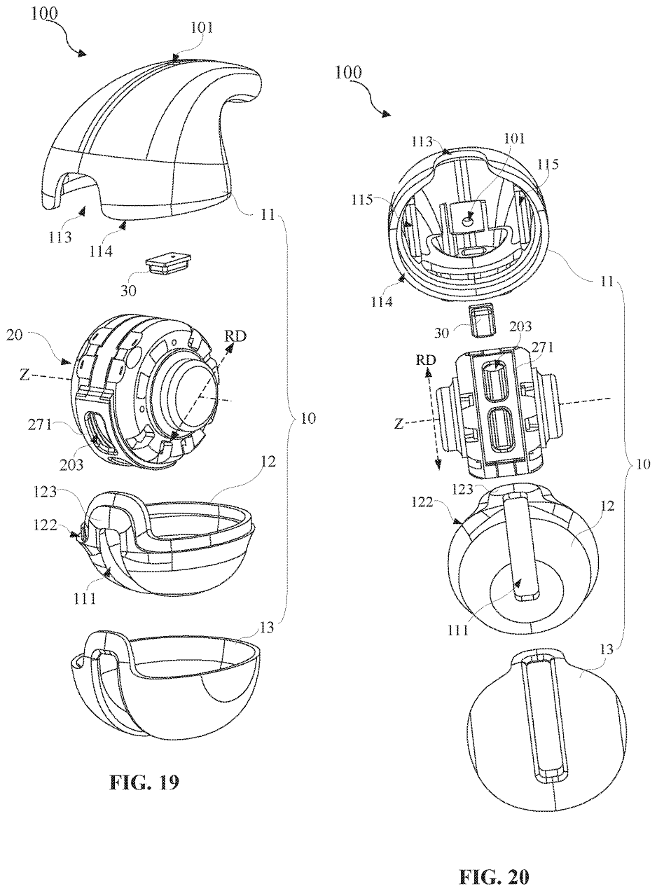

Optionally, referring to FIG. 7, FIG. 19, and FIG. 20, the first housing 10 may include a first rigid housing 11 and a second rigid housing 12. The first rigid housing 11 is connected to the ear hook 300. The first rigid housing 11 and the second rigid housing 12 enclose to form the first accommodating cavity 110. The sound outlet hole 111 is provided on the second rigid housing 12.

By configuring the first rigid housing 11 to connect to the ear hook 300 and providing the sound outlet hole 111 on the second rigid housing 12, the integrity of the sound outlet hole 111 is effectively ensured, reducing the possibility of interference to the sound outlet hole 111. This improves the stability and reliability of the sound outlet hole 111 during operation, and can reduce the difficulty of aligning the first rigid housing 11 and the second rigid housing 12, thereby reducing the assembly difficulty of the sound generating assembly 20 and improving the assembly efficiency of the sound generating assembly 20. Furthermore, with such an arrangement, the sound outlet hole 111 does not need to penetrate both the first rigid housing 11 and the second rigid housing 12 simultaneously, which can avoid uneven surfaces of the sound outlet hole 111 that might affect the installation of a tuning mesh and a steel mesh.

Optionally, as shown in FIG. 19 and FIG. 20, the second rigid housing 12 is provided with a protruding block 123 protruding with respect to an end surface 122 of the second rigid housing 12. The first rigid housing 11 is provided with a groove 113 recessed with respect to an end surface 114 of the first rigid housing 11. The protruding block 123 is embedded in the groove 113. The sound outlet hole 111 is partially provided in the protruding block 123. By providing the protruding block 123 and the groove 113 to achieve the connection between the first rigid housing 11 and the second rigid housing 12, and providing the sound outlet hole 111 partially in the protruding block 123, the connection stability between the first rigid housing 11 and the second rigid housing 12 is ensured while giving the sound outlet hole 111 sufficient length. This is beneficial for improving the sound output effect of the earphone 1 and enhancing the sound quality of the earphone 1.

Optionally, as shown in FIG. 19 and FIG. 20, the mounting boss 271 is disposed on the sound generating assembly 20. Certainly, the mounting boss 271 may also be disposed on the second rigid housing 12. The first rigid housing 11 is provided with a third support platform 115 inside. The third support platform 115 is configured to support the sound generating assembly 20 to hold the sound generating assembly 20 and the second rigid housing 12 to abut against each other through the mounting boss 271 when the first rigid housing 11 and the second rigid housing 12 are fixed to each other. Such an arrangement can simplify the structure and assembly process, reduce assembly difficulty, and improve assembly efficiency.

Optionally, as shown in FIG. 7, when the sound generating assembly 20 and the second rigid housing 12 abut against each other through the mounting boss 271, the end surface 114 of the first rigid housing 11 and the end surface 122 of the second rigid housing 12 may maintain a certain gap along a direction of abutment between the sound generating assembly 20 and the second rigid housing 12. This configuration allows that when the sound generating assembly 20 is positioned and mounted by abutting it with the first rigid housing 11 and the second rigid housing 12, a gap is maintained between the first rigid housing 11 and the second rigid housing 12 to compensate for assembly errors of the sound generating assembly 20, thereby effectively improving the accuracy and stability of the positioning and installation of the sound generating assembly 20. Furthermore, during the production and assembly process, the mounting boss 271 first abuts against the sound generating assembly 20 and the second rigid housing 12, and then the first rigid housing 11 is engaged with the second rigid housing 12, thereby squeezing the sound generating assembly 20 and the second rigid housing 12 to achieve further fixation, effectively improving the abutment effect and enhancing the connection stability of the earphone 1.

Optionally, the axial direction (i.e., the direction of the axis Z) may be perpendicular to the direction of abutment between the sound generating assembly 20 and the second rigid housing 12. Optionally, the magnetic circuit system 24 includes a magnetic conductive shield 241 protruding from the frame 25 and a magnet 242 disposed in the magnetic conductive shield 241. As shown in FIG. 7 and FIG. 19, the third support platform 115 is configured to support magnetic conductive shields 241 of the two speakers 21. This configuration achieves installation and fixation of the sound generating assembly 20 without affecting the vibration of the diaphragm 22. The structure is stable, which is beneficial for improving the service life of the earphone 1.

Optionally, as shown in FIG. 9 and FIG. 15, the sound outlet hole 111 and the pressure relief hole 112 are respectively mirror-symmetric with respect to a symmetry plane SF arranged along a length direction of the ear hook 300.

By providing the sound outlet hole 111 and the pressure relief hole 112 that are respectively mirror-symmetric with respect to the symmetry plane SF, the aesthetics of the earphone 1 are improved while allowing the earphone 1 to be suitable for both the left ear and the right ear, thereby effectively enhancing the adaptability of the earphone 1.

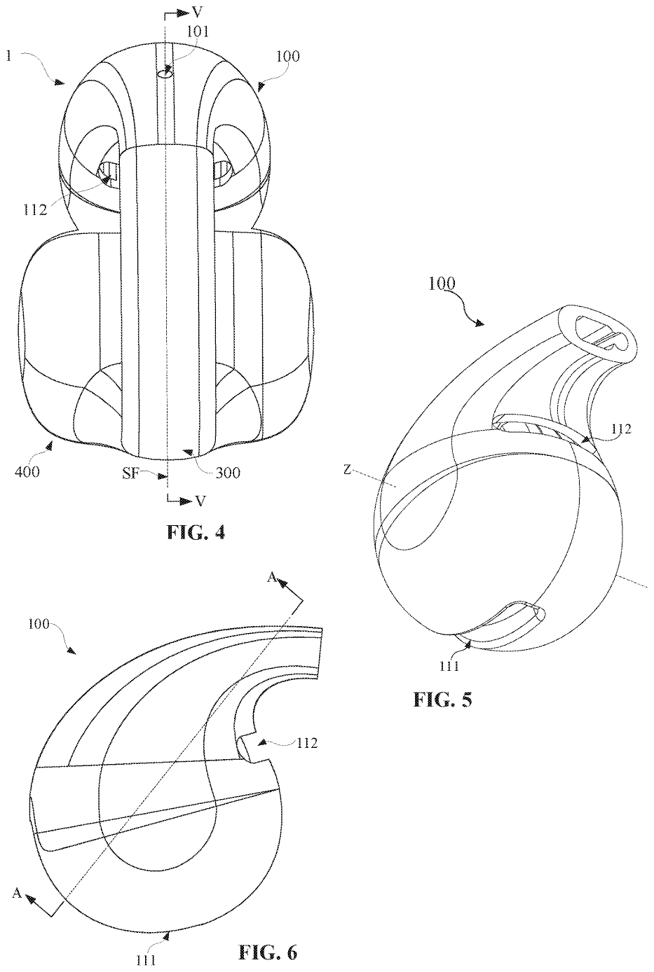

Optionally, as shown in FIG. 4, the earphone 1 further includes a microphone 30. The first housing 10 is provided with a sound inlet 101 for guiding external sound to the microphone 30. The sound inlet 101 is disposed intersecting the symmetry plane SF. The microphone 30 may be used to collect sound, enabling the earphone 1 to adapt to different usage scenarios such as music playback and calls. Disposing the sound inlet 101 to intersect with the symmetry plane SF ensures the effectiveness of sound collection by the microphone 30 through the sound inlet 101, while allowing the earphone 1 to be suitable for both the left ear and the right ear, effectively enhancing the adaptability of the earphone 1. A cross-section corresponding to a section line V-V in FIG. 4 is the symmetry plane SF.

Optionally, a count of microphones 30 may be set to one or more. For example, the count of the microphones 30 may be 1, 2, 4, etc. When the count of the microphones 30 is one, the microphone 30 is disposed intersecting the symmetry plane SF. When the count of the microphones 30 is multiple, the multiple microphones 30 are symmetrically distributed relative to the symmetry plane SF. This configuration can further enable the earphone 1 to be suitable for both the left ear and the right ear, effectively enhancing the adaptability of the earphone 1.

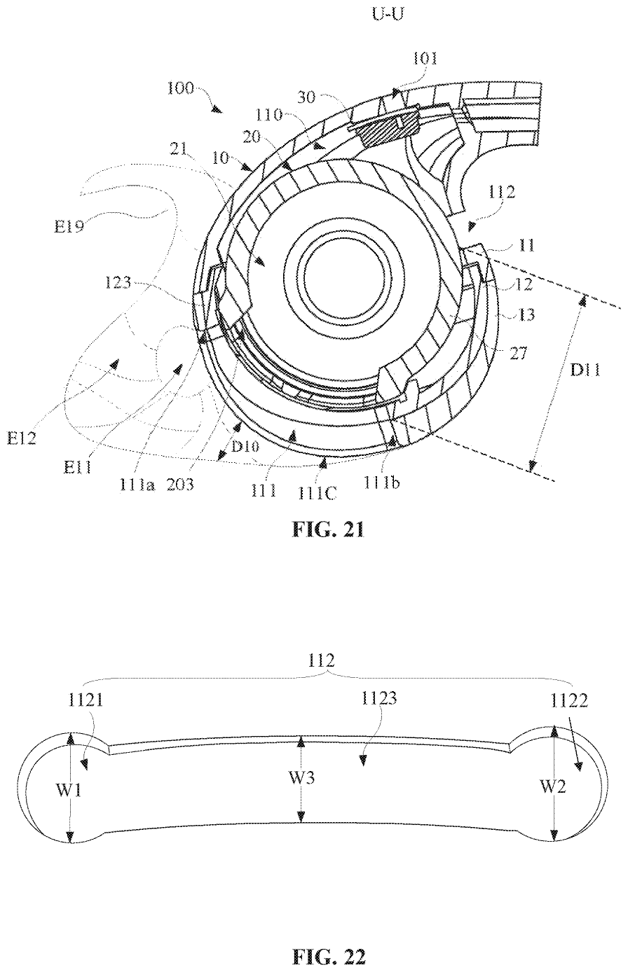

Optionally, as shown in FIG. 21, FIG. 21 is a cross-sectional schematic diagram of the structure of the sound generating component 100 with the symmetry plane SF as a section. A minimum spacing distance D10 between the sound outlet hole 111 and the pressure relief hole 112 may be in a range of 6.5 mm to 10 mm. Optionally, the minimum spacing distance D10 is not less than 7 mm. FIG. 21 uses the symmetry plane SF as the section. Acoustic short circuit refers to a phenomenon where, when the diaphragm 22 of the speaker 21 moves forward or backward, the generated sound waves are in phase opposition and cancel each other out, resulting in a lighter or unnatural sound. If the spacing distance D10 is too short, the acoustic short circuit may occur. By reasonably setting the spacing distance D10 between the sound outlet hole 111 and the pressure relief hole 112, the possibility of the acoustic short circuit can be effectively reduced, which is beneficial for improving the sound quality of the earphone 1.

Optionally, as shown in FIG. 1 and FIG. 17, the pressure relief hole 112 may be provided towards the helix. The sound outlet hole 111 and the pressure relief hole 112 are spaced apart from each other by a contact region between the first housing 10 and the EAR. The contact region may be a contact region between the first housing 10 and the antihelix or the concha cavity. By spacing the sound outlet hole 111 and the pressure relief hole 112 apart from each other by the contact region of the first housing 10, an interference between the sound outlet hole 111 and the pressure relief hole 112 can be effectively reduced, thereby effectively improving the operational reliability of the earphone 1, benefiting the sound quality of the earphone 1, and simultaneously making the earphone 1 suitable for both the left ear and the right ear of the user with high adaptability.

Optionally, as shown in FIG. 9 and FIG. 21, a count of sound outlet holes 111 is one. The sound outlet hole is arranged in a strip shape. A symmetry plane is arranged along a length direction of the sound outlet hole 111 and is perpendicular to the axial direction (i.e., the direction of the axis Z). With this configuration, when the earphone 1 is worn by the user, the first housing 10 and the concha cavity of the EAR of the suer are not completely attached but have a space that gradually increases from the contact region between the first housing 10 and the EAR towards an entrance of the ear canal. Therefore, the sound output from the sound outlet hole 111 is reflected and enhanced within the concha cavity, utilizing the reflection effect to increase the sound pressure at the entrance of the ear canal, so that the user can hear sound with greater intensity.

Optionally, as shown in FIG. 15 and FIG. 21, a count of pressure relief holes 112 is one. The pressure relief hole 112 is arranged in a strip shape. The symmetry plane SF is arranged along a width direction of the pressure relief hole 112 and is perpendicular to the axial direction (i.e., the direction of the axis Z). This configuration allows the pressure relief hole 112 and the sound outlet hole 111 to be as far apart as possible, effectively reducing the possibility of an acoustic short circuit, which is beneficial for improving the sound quality of the earphone 1.

Optionally, as shown in FIG. 22, the pressure relief hole 112 includes a first aperture part 1121 and a second aperture part 1122 along a length direction of the pressure relief hole 112, and a third aperture part 1123 connected between the first aperture part 1121 and the second aperture part 1122. Both a width W1 of at least a portion of the first aperture part 1121 and a width of at least a portion of the second aperture part 1122 are greater than a width W3 of the third aperture part 1123. The width of the first aperture part 1121, the width of the second aperture part 1122, and the width of the third aperture part 1123 refer to a dimension in a width direction perpendicular to the length direction of the pressure relief hole 112. This configuration increases an area of the pressure relief hole 112 while effectively reducing the possibility of the pressure relief hole 112 being blocked by the helix or other parts of the EAR, which is beneficial for improving the pressure relief effect and thereby beneficial for improving the sound quality of the earphone 1. Moreover, with this configuration, while maintaining the pressure relief effect, the pressure relief hole 112 as a whole does not need to be configured with a maximum width, making its size relatively moderate and also facilitating the improvement of the aesthetics of the earphone 1.

Optionally, the symmetry plane SF is a symmetry plane of the ear hook 300. Specifically, the symmetry plane of the ear hook 300 refers to a plane arranged along a length direction of the ear hook 300, where parts of the ear hook 300 on two sides of the symmetry plane have minimal or no differences. That is, if the ear hook 300 is regularly symmetrical, the parts of the ear hook 300 on the two sides of the symmetry plane are identical. If the ear hook 300 is not strictly symmetrical, the difference between the parts of the ear hook 300 on the two sides of the symmetry plane SF should be the smallest among various division manners. For example, a projection of the ear hook 300 may be observed on a plane perpendicular to the symmetry plane to distinguish the magnitude of the difference.

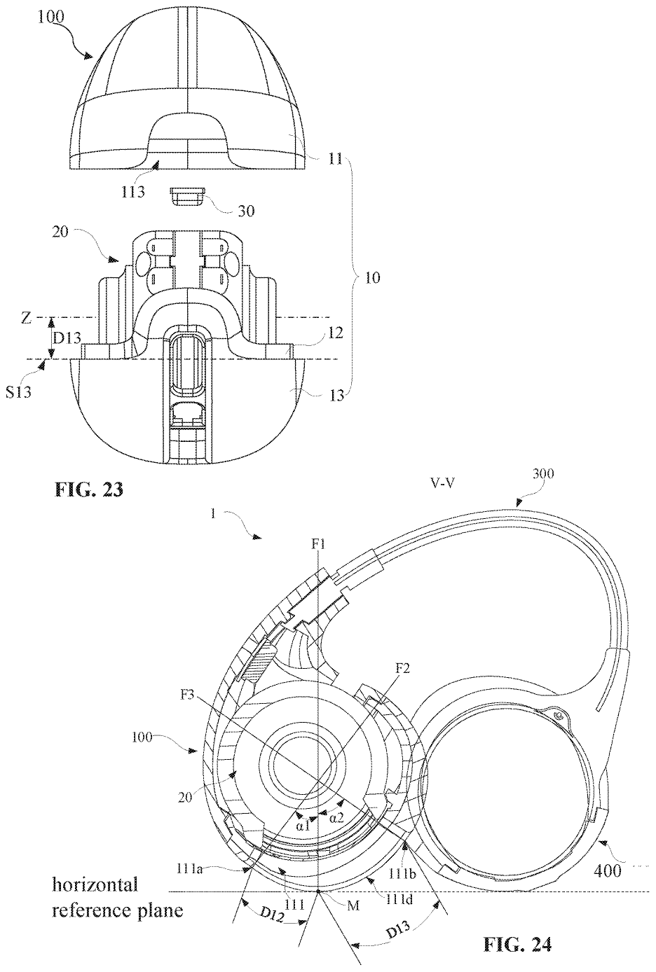

Optionally, as shown in FIG. 19, FIG. 20, and FIG. 23, the first housing 10 may further include a first flexible body 13. The first rigid housing 11 and the second rigid housing 12 enclose to form the first accommodating cavity 110. The first flexible body 13 is provided on an outer wall of the second rigid housing 12 and is configured to contact the concha cavity. A plane in which an outermost annular line of an end surface of the first flexible body 13 is located is a first reference plane S13. A midpoint of the sound generating assembly 20 along the axis Z (or the axis Z of the sound generating assembly 20) is located on a side of the first reference plane S13 toward the first rigid housing 11. The axis Z of the sound generating assembly 20 is parallel to the first reference plane S13.

The rigid material may be plastic, metal, or other materials that can be used as a support material for the housing of the earphone 1, to provide better support and stability for internal structures of the first housing 10, such as the sound generating assembly 20. The first flexible body 13 covers the outer wall of the second rigid housing 12. The first flexible body 13 may be made of silicone or other skin-friendly flexible materials to improve comfort when the sound generating component 100 contacts the wearer. Typically, in the wearing state, the second rigid housing 12 faces the concha cavity of the wearer and may contact the wearer. By covering the outer wall of the second rigid housing 12 with the first flexible body 13, the wearing comfort of the earphone 1 is improved. Furthermore, by arranging the midpoint of the sound generating assembly 20 along the axis Z (or the axis Z of the sound generating assembly 20) to be located on the side of the first reference plane S13 toward the first rigid housing 11, a center of the entire sound generating assembly 20 can be brought closer to the first rigid housing 11. That is, when the first flexible body 13 is disposed on the outer wall of the second rigid housing 12, a centroid of the first housing 10 and a centroid of the sound generating assembly 20 do not coincide. The centroid of the sound generating assembly 20 is biased towards the first rigid housing 11 relative to the centroid of the first housing 10, thereby achieving an eccentric arrangement of the sound generating assembly 20. This allows for more utilization of the internal space of the first rigid housing 11, which is beneficial for improving space utilization.

Optionally, a distance D13 between the midpoint of the sound generating assembly 20 along the axis Z or the axis Z and the first reference plane S13 may be in a range of 0.4 mm to 4 mm. Arranging the position of the sound generating assembly 20 within the first housing 10 in this way allows a larger volume of the sound generating assembly 20 to be distributed towards the first rigid housing 11, thereby fully utilizing the relatively ample internal space of the first rigid housing 11 and enabling the first housing 10 to accommodate a sound generating unit with a larger volume.

Optionally, the sound generating component 100 may be provided to keep at least a part of an earhole open within the concha cavity, reducing the possibility of affecting sound transmission into the ear canal of the user due to blocking the earhole, and facilitating sound reflection within the concha cavity of the user to increase the listening volume.

In some embodiments, optionally, as shown in FIG. 11, a ratio of the maximum axial dimension Z21 of the sound generating assembly 20 to the maximum radial dimension R20 may be in a range of 0.8 to 1.3. Optionally, the ratio of the maximum axial dimension Z21 of the sound generating assembly 20 to the maximum radial dimension R20 may be 0.9, 1, 1.1, 1.2, etc. Thus, the maximum axial dimension Z21 and the maximum radial dimension R20 of the sound generating assembly 20 are very close, making an outer contour of the sound generating assembly 20 closer to spherical. This effectively improves the structural compactness and integration of the sound generating assembly 20, effectively reducing assembly difficulty and improving assembly efficiency.

Optionally, the maximum radial dimension R20 of the sound generating assembly 20 is set as a maximum radial dimension of the mounting bracket 27 or the frame 25. This allows the mounting bracket 27 or the frame 25 to serve as the main load-bearing component during assembly, effectively protecting the diaphragm 22 and the voice coil 23, and effectively improving the reliability and effectiveness of the operation of the sound generating assembly 20. Optionally, the maximum axial dimension of the sound generating assembly 20 is set as a maximum axial dimension between the magnetic conductive shields 241 of the two speakers 21 along the axial direction (i.e., the direction of the axis Z).

Optionally, in some embodiments, each of the diaphragms 22 of the two speakers 21 has a resonant peak frequency in a range of 200 Hz to 300 Hz. An absolute difference of the resonant peak frequencies of the diaphragms 22 of the two speakers 21 is less than or equal to 50 Hz. Here, the corresponding resonant peak may be the first resonant peak that appears during a frequency sweep from low frequency to high frequency. Specifically, the resonant peak frequency refers to a frequency of the first resonant peak that appears in sequence from low frequency to high frequency when performing an electroacoustic frequency sweep test on the structure composed of, for example, the speaker 21, the first housing 10, and internal cavities of the first housing 10 within the sound generating component 100. The position where this resonant peak appears corresponds to a position where an impedance curve of the sound generating component 100 increases sharply.

By using the speaker 21 with a resonant peak frequency within a reasonable range, the type and range of sound domains that the speaker 21 can reproduce are wider, providing better sound quality not only for vocals but also for music playback. Furthermore, the absolute difference between the resonant peak frequencies of the two speakers 21 being less than or equal to 50 Hz indicates a high consistency between the two speakers 21, which further enhances the sound quality of the earphone 1.

In some embodiments, as shown in FIG. 21, the sound outlet hole 111 is arranged in a strip shape and has a first end 111a and a second end 111b spaced apart along the length direction of the sound outlet hole 111. In the wearing state, the first end 111a may be oriented toward the earhole E11, and the distance D10 between the outer wall surface of the first housing 10 at the second end 111b and an inner wall surface of the concha cavity E12 is less than the distance D10 between the outer wall surface of the first housing 10 at the first end 111a and the inner wall surface of the concha cavity E12.

By arranging the first housing 10 such that the first end 111a of the sound outlet hole 111 faces the earhole, sound waves can enter the earhole through the sound outlet hole 111 as much as possible, effectively shortening a transmission path of the sound waves, effectively improving a volume effect of sound heard by the user, and facilitating improvement of sound quality of the earphone 1. In addition, by setting the distance D10 between the outer wall surface of the first housing 10 at the second end 111b and the inner wall surface of the concha cavity E12 to be less than the distance D10 between the outer wall surface of the first housing 10 at the first end 111a and the inner wall surface of the concha cavity E12, a wedge-shaped space can be formed between a curve formed by an outer ring of the speaker 21 cutting the first housing 10 and the concha cavity. When the sound outlet hole 111 is arranged along the curve, a horn structure can be formed between the sound outlet hole 111 and the concha cavity. Using the concha cavity E12 as a reflection wall surface can form sound wave reflection enhancement, thereby effectively increasing sound pressure at the earhole and effectively increasing the listening volume.

Optionally, as shown in FIG. 21, at the second end 111b and/or on a side of the second end 111b away from the first end 111a, the outer wall surface of the first housing 10 and the inner wall surface of the concha cavity are in contact with each other. With this arrangement, sound propagation in a direction away from the earhole can be blocked, which is more conducive to forming a horn structure between the first housing 10 and the concha cavity for reflecting sound toward the earhole, thereby facilitating the reduction of sound leakage of the earphone 1, effectively increasing the sound pressure at the earhole, and effectively increasing the listening volume.

Optionally, as shown in FIG. 21, the outer wall surface of the first housing 10 is configured such that a long edge 111c of the sound outlet hole 111 is arranged in an arc shape. The distance D10 between the outer wall surface of the first housing 10 and the inner wall surface of the concha cavity gradually increases in a direction from the second end 111b to the first end 111a. This arrangement allows sound to be reflected toward the earhole within the horn structure formed between the concha cavity E12 and the outer wall surface of the first housing 10, rather than being reflected in a direction away from the earhole, effectively improving the sound output effect of the earphone 1, effectively increasing the sound pressure at the earhole, and effectively increasing the listening volume.

Optionally, as shown in FIG. 21, an arc-to-chord ratio (i.e., a ratio of an arc length to a chord length) of the long edge 111c of the sound outlet hole 111 may be in a range of 1.05 and 1.4, for example, the arc-to-chord ratio may be 1.1, 1.2, 1.3, etc. A symmetry plane is arranged along a length direction of the ear hook 300. The arc-to-chord ratio of the long edge 111c of the sound outlet hole 111 is an arc-to-chord ratio of a projection contour of the long edge 111c on the symmetry plane. In some embodiments, an arc length of the long edge 111c of the sound outlet hole 111 may be 10 mm, and a chord length of the long edge 111c of the sound outlet hole 111 may be 8.87 mm. Optionally, an aspect ratio (a length to a width) of the sound outlet hole 111 may be in a range of 0.15 to 0.30, for example, 0.18, 0.20, 0.25, etc. Optionally, a length of the sound outlet hole 111 may be in a range of 9 mm to 16.5 mm, for example, 10 mm, 12 mm, 13 mm, 14 mm, 16 mm, etc. In some embodiments, an inner width of the sound outlet hole 111 may be 1.95 mm, an outer width of the sound outlet hole 111 may be 2.58 mm, and the length of the sound outlet hole 111 may be 12.9 mm. By reasonably setting the arc length, chord length, width, and length of the long edge 111c of the sound outlet hole 111, the size of the sound outlet hole 111 can better conform to the size and shape of the concha cavity and the earhole, making it easier to form the horn structure for enhancing sound, effectively improving the sound output effect of the earphone 1, effectively increasing the sound pressure at the earhole, and effectively increasing the listening volume.

Optionally, the arc-to-chord ratio of the long edge 111c of the sound outlet hole 111 may be in a range of 1.05-1.4, or is greater than or equal to 1.02 and less than 1.05. For example, the arc-to-chord ratio of the long edge 111c of the sound outlet hole 111 may be 1.02, 1.04, 1.05, 1.1, 1.2, 1.3, and the like. Optionally, the length of the sound outlet hole 111 ranges from 9 mm to 16.5 mm, or is greater than or equal to 5 mm and less than 9 mm. For example, the length of the sound outlet hole 111 may be 5 mm, 6 mm, 7 mm, 8 mm, 9 mm, 10 mm, 12 mm, 13 mm, 14 mm, 16 mm, and the like. By reasonably configuring the arc-to-chord ratio of the long edge 111c and the length of the sound outlet hole 111, the dimension of the sound outlet hole 111 can better conform to the size and shape of the concha cavity and the ear canal, which facilitates the formation of a horn structure for sound reinforcement, effectively improves the sound output effect of the earphone 1, increases the sound pressure at the ear hole, and raises the listening volume significantly.

Optionally, as shown in FIG. 24, when the sound generating component 100 and the abutting component 400 are simultaneously placed on a horizontal reference plane, the long edge 111c of the sound outlet hole 111 forms a first reference point M between the first end 111a and the second end 111b with the horizontal reference plane. The second end 111b is located on a side of the first reference point M toward the abutting component 400. The first end 111a is located on a side of the first reference point M away from the abutting component 400. This arrangement allows the first end 111a of the sound outlet hole 111 to be closer to the earhole, while a portion of the first housing 10 near the second end 111b can abut against the concha cavity and, together with the abutting component 400, clamp on two sides of the ear of the user. This achieves stable clamping of the EAR while utilizing the concha cavity to increase the volume and sound pressure. Furthermore, the portion of the first housing 10 abutting against the concha cavity can further block sound propagation away from the earhole, facilitating the reduction of sound leakage.

Optionally, a length D12 of the long edge 111c of the sound outlet hole 111 between the first end 111a and the first reference point M is in a range of 2 mm to 5.5 mm. For example, the length D12 may be 2.55 mm, 3.56 mm, 4 mm, 4.76 mm, etc. A length D13 of the long edge 111c of the sound outlet hole 111 between the second end 111b and the first reference point Mis in a range of 4.5 mm to 8 mm. For example, the length D13 may be 5.53 mm, 6 mm, 6.73 mm, 7.81 mm, etc. The aforementioned lengths all refer to distances between corresponding positions on the projection contour of the sound outlet hole 111 on the symmetry plane. By reasonably setting the distances from the first end 111a and the second end 111b to the first reference point M, the enhancement effect of sound wave propagation from the concha cavity E12 toward the earhole can be further improved, effectively increasing the sound pressure at the earhole, and effectively increasing the listening volume.

Optionally, an arc-to-chord ratio of the long edge of the sound outlet hole 111 between the first end 111a and the first reference point M may be in a range of 1.02 to 1.05, for example, the arc-to-chord ratio may be 1.03, 1.04, etc. An arc-to-chord ratio of the long edge of the sound outlet hole 111 between the second end 111b and the first reference point M is in a range of 1.02 to 1.05, for example, the arc-to-chord ratio may be 1.03, 1.04, or the like. The aforementioned arc-to-chord ratios all refer to arc-to-chord ratios of edges between corresponding positions on the projection contour of the sound outlet hole 111 on the symmetry plane. By reasonably setting the arc-to-chord ratio of the long edge 111c of the sound outlet hole 111 between the first end 111a and the first reference point M and the arc-to-chord ratio of the long edge 111c of the sound outlet hole 111 between the second end 111b and the first reference point M, the sound reflection effect of the horn structure formed by the outer wall surface of the first housing 10 and the concha cavity is improved while adapting to the shape of the concha cavity of the user to ensure wearing comfort, effectively improving the listening volume and the experience of the user.

Optionally, the arc-to-chord ratio of the long edge of the sound outlet hole 111 between the first end 111a and the first reference point M ranges from 1.02 to 1.05, or is greater than or equal to 1.001 and less than 1.02, such as 1.001, 1.005, 1.01, 1.02, 1.03, 1.04 and the like. The arc-to-chord ratio of the long edge of the sound outlet hole 111 between the second end 111b and the first reference point M ranges from 1.02 to 1.05, or is greater than 1.05 and less than or equal to 1.07, such as 1.03, 1.04, 1.05, 1.06, 1.07 and the like. All the above arc-to-chord ratios refer to the arc-to-chord ratio between corresponding positions on the projection contour of the sound outlet hole 111 on the symmetry plane. By reasonably setting the arc-to-chord ratios of the long edge 111c of the sound outlet hole 111 between the first end 111a or the second end 111b and the first reference point M, the shape of the user's concha cavity can be adapted to ensure wearing comfort. Meanwhile, the sound reflection effect of the horn structure formed by the outer wall surface of the first housing 10 and the concha cavity is improved, thereby effectively increasing the listening volume and optimizing the user experience.

Optionally, as shown in FIG. 24, the long edge 111c of the sound outlet hole 111 has a first normal direction F1 at the first reference point M, a second normal direction F2 at the first end 111a, and a third normal direction F3 at the second end 111b. An included angle α1 between the first normal direction F1 and the second normal direction F2 may be in a range of 30° to 42°. An included angle α2 between the first normal direction F1 and the third normal direction F3 may be in a range of 50° and 60°. The included angle α1 between the first normal direction F1 and the second normal direction F2 may be, for example, 32°, 35°, 37°, etc. The included angle α2 between the first normal direction F1 and the third normal direction F3 may be, for example, 53°, 55°, 57°, etc. The aforementioned included angles all refer to angles between corresponding directions on the projection contour of the sound outlet hole 111 on the symmetry plane. By reasonably setting the aforementioned included angles, the sound reflection effect of the horn structure formed between the outer wall surface of the first housing 10 and the concha cavity is improved while ensuring the spatial size of the sound outlet hole 111, effectively improving the listening volume and the experience of the user.

Optionally, as shown in FIG. 24, the long edge 111c of the sound outlet hole 111 has a first normal direction F1 at the first reference point M, the long edge 111c of the sound outlet hole 111 has a second normal direction F2 at the first end 111a, and the long edge 111c of the sound outlet hole 111 has a third normal direction F3 at the second end 111b. An included angle α1 between the first normal direction F1 and the second normal direction F2 ranges from 30° to 42°, or is greater than or equal to 15° and less than 30°. An included angle α2 between the first normal direction F1 and the third normal direction F3 ranges from 50° to 60°, or is greater than or equal to 25° and less than 50°. For example, the included angle α1 between the first normal direction F1 and the second normal direction F2 may be 15°, 20°, 25°, 30°, 32°, 35°, 37°, and the like; the included angle α2 between the first normal direction F1 and the third normal direction F3 may be 25°, 30°, 35°, 40°, 50°, 53°, 55°, 57°, and the like. The aforementioned included angles all refer to angles between corresponding directions on the projection contour of the sound outlet hole 111 on the symmetry plane. By reasonably setting the aforementioned included angles, the sound reflection effect of the horn structure formed between the outer wall surface of the first housing 10 and the concha cavity is improved while ensuring the spatial size of the sound outlet hole 111, effectively improving the listening volume and the experience of the user.

Optionally, as shown in FIG. 9, the sound outlet hole 111 has a median line along the length direction of the sound outlet hole 111. The sound outlet hole 111 intersects with a reference cross-section SF provided along the length direction of the ear hook 300, and an included angle between a plane where the median line lies and the reference cross-section SF is in a range of 0° to 45°. Furthermore, the sound outlet hole 111 is offset toward an earlobe direction. The median line may be a virtual curve that divides the sound outlet hole 111 into two equal parts along the length direction. Preferably, the sound outlet hole 111 intersects with the reference cross-section SF arranged along the length direction of the ear hook 300, and the included angle between the plane where the median line lies and the reference cross-section SF is in a range of 15° to 45°, for example, the included angle may be 20°, 30°, etc. In some embodiments, the reference cross-section SF may coincide with the symmetry plane arranged along the length direction of the ear hook 300. Therefore, the symmetry plane is also labeled as the symmetry plane SF in subsequent descriptions. Thus, the reference cross-section SF may be arranged along the length direction of the ear hook 300, and portions of the ear hook 300 on both sides of the reference cross-section SF have minimal differences or are consistent. Certainly, in other embodiments, the reference cross-section SF and the symmetry plane of the ear hook are parallel to each other but may be offset by a small spacing.

By reasonably setting the included angle between the median line of the sound outlet hole 111 and the reference cross-section SF of the ear hook 300, and arranging the sound outlet hole 111 to be offset toward the earlobe direction, sound output from the sound outlet hole 111 is directed toward the earhole as much as possible while ensuring user wearing comfort, effectively improving the user experience of the earphone 1. Specifically, when the user naturally wears the earphone 1, the earphone 1 may tilt downward under gravity due to the movements of the user. This arrangement ensures that the sound outlet hole 111 faces the earhole as much as possible, even when the earphone 1 is tilted, effectively increasing the listening volume for the user when the earphone 1 is in a tilted state and improving the user experience.

Optionally, the plane where the median line lies and the reference cross-section SF coincide with each other. Alternatively, the sound outlet hole 111 is mirror-symmetric with respect to the reference cross-section SF. This arrangement allows the earphone 1 to be adapted for wearing and use on both the left ear and the right ear, effectively improving the adaptability of the earphone 1 while ensuring user wearing comfort.

Optionally, as shown in FIG. 25, on the reference cross-section SF, the sound generating component 100 has a second reference point N closest to the abutting component 400. In some embodiments, in a natural state, the sound generating component 100 and the abutting component 400 do not directly contact each other. Then, the second reference point Nis an intersection point between a shortest connecting line between the sound generating component 100 and the abutting component 400, and the outer wall surface of the sound generating component 100. A midpoint of the shortest connecting line between the sound generating component 100 and the abutting component 400 is O. In other embodiments, in the natural state, the sound generating component 100 and the abutting component 400 are just in contact or a contact region between them is very small. Then, a contact point between the sound generating component 100 and the abutting component 400 is considered as the second reference point N. In still other embodiments, in the natural state, the sound generating component 100 and the abutting component 400 have a relatively large contact region. Then, on the reference cross-section SF, a midpoint of an arc corresponding to a contact region between the outer wall surface of the sound generating component 100 and the abutting component 400 is the second reference point N.

An inner contour of the ear hook 300 has a third reference point C farthest from the second reference point N in a region close to an edge of the helix in the wearing state. The sound outlet hole 111 is located on a side of the second reference point N away from the third reference point C, and on the outer wall surface of the sound generating component 100. A distance D13 from the second end 111b to the second reference point N may be in a range of 2.2 mm to 4.2 mm, and a distance from the first end 111a to the second reference point N may be in a range of 9 mm to 12.4 mm. The distance from the second end 111b to the second reference point N may be, for example, 2.3 mm, 2.6 mm, 2.9 mm, etc. The distance from the first end 111a to the second reference point N may be 9.8 mm, 10.7 mm, 11.6 mm, etc., and may also be other values. The aforementioned distances all refer to distances between corresponding positions on the projection contour of the sound outlet hole 111 on the symmetry plane.

Optionally, as shown in FIG. 15, a pressure relief hole 112 faces the helix and intersects with the reference cross-section SF. Alternatively, the pressure relief hole 112 faces the helix and is mirror-symmetric with respect to the reference cross-section SF. This arrangement can effectively reduce the possibility of interference between the pressure relief hole 112 and the sound outlet hole 111 while ensuring the pressure relief effect of the pressure relief hole 112, effectively improving the operational stability and reliability of the earphone 1.

Optionally, as shown in FIG. 1 and FIG. 21, the pressure relief hole 112 and the sound outlet hole 111 are spaced apart from each other by a contact region between the sound generating component 100 and the EAR (e.g., the concha cavity). Spacing the sound outlet hole 111 and the pressure relief hole 112 apart by the contact region of the sound generating component 100 can effectively reduce the possibility of acoustic short circuit between the sound outlet hole 111 and the pressure relief hole 112, thereby effectively improving the operational reliability of the earphone 1, improving of the sound quality of the earphone 1, and simultaneously adapting to the left ear and right ear of the user with high adaptability.

Optionally, as shown in FIG. 15, a count of the pressure relief holes 112 is one. The pressure relief hole 112 is arranged in a strip shape. The reference cross-section SF is arranged along the width direction of the pressure relief hole 112. The pressure relief hole 112 is mirror-symmetric with respect to the reference cross-section SF. This arrangement ensures an area for pressure relief to effectively guarantee the pressure relief effect of the pressure relief hole 112 while preventing the pressure relief hole 112 from extending excessively toward the direction of the ear hook 300, which is beneficial for improving the aesthetics of the earphone 1.

Optionally, the count of the pressure relief holes 112 is two, which are respectively disposed on two sides of the reference cross-section SF and are mirror-symmetric with respect to the reference cross-section SF. The reference cross-section SF is arranged along the width direction of any one of the pressure relief holes 112 (that is, the reference cross-section SF is parallel to the width direction of the pressure relief hole 112, with a tolerance within 15°). Such arrangement ensures an area for pressure relief to effectively guarantee the pressure relief effect of the pressure relief hole 112 while preventing the pressure relief hole 112 from extending excessively toward the direction of the ear hook 300, which is beneficial for improving the aesthetics of the earphone 1. Optionally, as shown in FIG. 15, the pressure relief hole 112 may be mirror-symmetric with respect to the reference cross-section SF, which improves the aesthetics of the earphone 1 while allowing the earphone 1 to adapt to wearing on the left ear and the right ear, effectively improving the adaptability of the earphone 1.

Optionally, as shown in FIG. 15 to FIG. 17, the sound generating assembly 20 is provided with at least one second sound guiding hole 204 communicating with the pressure relief hole 112 through a first accommodating cavity. A distance between the at least one second sound guiding hole 204 and the pressure relief hole 112 is not greater than 0.5 mm. Alternatively, the distance between the at least one second sound guiding hole 204 and the pressure relief hole 112 is greater than 0.5 mm and less than or equal to 4 mm. Optionally, the distance between the at least one second sound guiding hole 204 and the pressure relief hole 112 is not greater than 3 mm. Optionally, the distance between the at least one second sound guiding hole 204 and the pressure relief hole 112 is not greater than 2 mm. Optionally, the distance between the at least one second sound guiding hole 204 and the pressure relief hole 112 is not greater than 0.4 mm. Optionally, the distance between the at least one second sound guiding hole 204 and the pressure relief hole 112 is not greater than 0.3 mm. If the distance from the sound guiding hole to the pressure relief hole 112 is too large, the pressure relief performance may be reduced, thereby affecting the sound quality of the earphone 1. By reasonably setting the distance from the sound guiding hole to the pressure relief hole 112, the pressure relief efficiency is effectively improved, which is beneficial for enhancing the sound quality of the earphone 1.

Optionally, as shown in FIG. 4, FIG. 19 to FIG. 21, the earphone 1 further includes the microphone 30. The first housing 10 is provided with the sound inlet 101 for guiding external sound to the microphone 30. The sound inlet 101 intersects with the reference cross-section SF. The microphone 30 may be used to collect sound, enabling the earphone 1 to adapt to different usage scenarios such as music playback and calls. Setting the sound inlet 101 to intersect with the reference cross-section SF ensures the effectiveness of sound collection by the microphone 30 through the sound inlet 101, while also allowing the earphone 1 to be used for both the left ear and the right ear, effectively improving the adaptability of the earphone 1. The cross-section corresponding to the section line V-V in FIG. 4 is the reference cross-section SF.

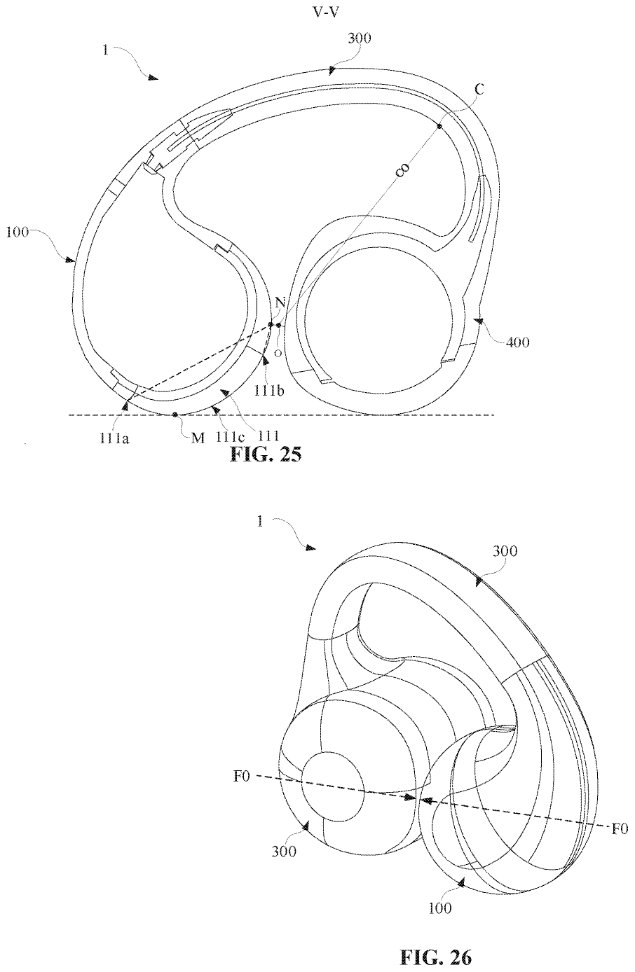

Optionally, the ear hook 300 provides an elastic force between the sound generating component 100 and the abutting component 400, so that the sound generating component 100 and the abutting component 400 have a clamping force F for clamping on two sides of the auricle in the wearing state. As shown in FIG. 26, the ear hook 300 is configured such that, in the natural state, the sound generating component 100 and the abutting component 400 abut against each other, thereby forming a preload force F₀.

In the wearing state, the ear hook 300 can undergo a certain elastic deformation to apply a certain elastic force on two sides of the helix of the user. Under the action of the elastic force, the sound generating component 100 and the abutting component 400 respectively abut against the two sides of the auricle to clamp the ear. However, if the elastic force provided by the ear hook 300 is too large, the clamping force F is excessive and may cause discomfort to the ear. If the elastic force is too small, the clamping force F is insufficient, making it difficult to wear stably.

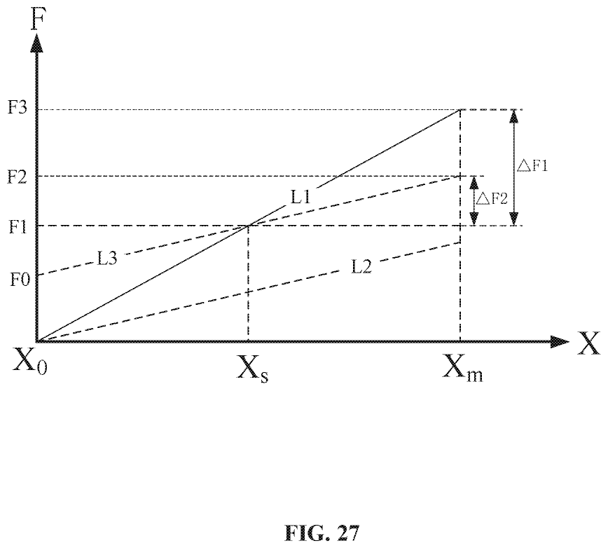

According to Hooke's law, an elastic force generated by elastic deformation of an object is directly proportional to a deformation amount of the object, and the corresponding ratio is an elastic coefficient. To meet the need for clamping ears with a smaller thickness, the elastic coefficient of the ear hook 300 is usually set to be relatively large. However, this can lead to excessive elastic force and pain when clamping ears with a larger thickness, resulting in poor wearing comfort. Furthermore, a larger elastic coefficient causes a significant variation in the clamping force F when adapting to ears of different thicknesses, leading to large differences in the clamping force F and consequently significant differences in user experience, indicating poor compatibility. As shown in FIG. 27, a clamping force variation line L1 represents a scenario without a preload force and with a large elastic coefficient, resulting in a large clamping force F and a large clamping force variation amount ΔF₁ when the distance between the sound generating component 100 and the abutting component 400 changes from Xₛ to Xₘ. Based on this, by configuring the ear hook 300 such that the sound generating component 100 and the abutting component 400 abut against each other in the natural state to form a preload force, the elastic coefficient of the ear hook 300 can be reduced. This results in a smaller variation in the elastic force applied by the ear hook 300 when clamping ears with both smaller and larger thicknesses, effectively reducing the difference in the clamping force F for ears of different thicknesses. This effectively improves the adaptability and wearing comfort of the earphone 1, allowing the earphone 1 to be worn by a wider range of users with different ear sizes. As shown in FIG. 27, compared to the clamping force variation line L1, a clamping force variation line L2, based on having the preload force F₀, exhibits a smaller clamping force F and a smaller clamping force variation amount ΔF₂ when the distance between the sound generating component 100 and the abutting component 400 changes from Xₛ to Xₘ. Therefore, the above technical effects can be effectively achieved, such as reducing the difference in clamping force F for ears with smaller and larger thicknesses, effectively improving the adaptability and wearing comfort of the earphone 1, and allowing the earphone 1 to be worn by a wider range of users with different ear sizes.

Based on extensive empirical research conducted by the applicant to improve the wearing comfort of the earphone 1, it was found that the ear thickness Xₛ for people with small ears is approximately 3.8 mm, and the ear thickness Xₘ for people with large ears is approximately 5.5 mm. After obtaining this data (e.g., the ear thickness Xₛ of people with small ears and the ear thickness Xₘ of people with large ears), the applicant conducted corresponding research on aspects such as the preload force and elastic coefficient of the earphone 1.

Optionally, the elastic coefficient of the ear hook 300 is set such that the variation amount of the elastic force is less than or equal to 20 grams-force when a minimum spacing between the sound generating component 100 and the abutting component 400 increases from 3.8 mm to 5.5 mm. For example, the variation amount may be 5 grams-force, 10 grams-force, or 15 grams-force. As shown in FIG. 27, based on having the preload force F₀, the clamping force F is relatively small when the distance between the sound generating component 100 and the abutting component 400 is Xₘ, and the clamping force variation amount ΔF₂ is also relatively small.

By reasonably setting the elastic coefficient, the change of the elastic force is small while meeting the clamping requirement. This ensures that the clamping force provided by the ear hook 300 has a small difference when clamping ears with larger and smaller thicknesses, effectively improving the adaptability of the earphone 1 while satisfying wearing comfort.

Optionally, the elastic coefficient and the preload force of the ear hook 300 are set such that the elastic force is in a range of 25 grams-force to 65 grams-force when the minimum spacing between the sound generating component 100 and the abutting component 400 increases from 3.8 mm to 5.5 mm. For example, the elastic force may be 30 grams-force, 40 grams-force, or 50 grams-force.

By reasonably setting the elastic coefficient and the preload force of the ear hook 300, an appropriate elastic force is provided, thereby providing a suitable clamping force F for the user in the wearing state, enhancing wearing comfort while ensuring wearing stability.

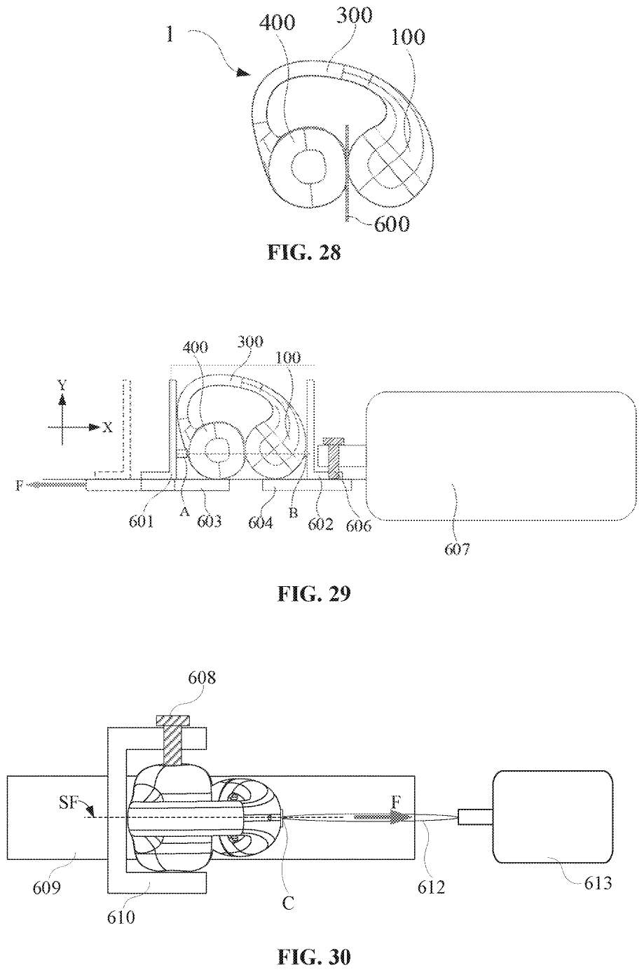

As shown in FIG. 28, the preload force F₀ may be measured by a thin-film pressure sensor 600. Specifically, it is measured by clamping the thin-film pressure sensor 600 between the abutting component 400 and the sound generating component 100. In other embodiments, as shown in FIG. 29 and FIG. 30, the preload force F₀ may also be measured by a tension meter/sensor 607, 613. For example, by fixing one of the sound generating component 100 and the abutting component 400 and pulling the other one until the sound generating component 100 and the abutting component 400 just contact/separate, or until the minimum distance between them is a small distance, the measured tension is the preload force. The small distance is, for example, 0 mm to 0.8 mm.

As shown in FIG. 29 and FIG. 30, the clamping force F may be measured when the sound generating component 100 and the abutting component 400 are arranged horizontally. Specifically, the abutting component 400 is fixed by the tension meter/sensor, and the sound generating component 100 is pulled for measurement. For example, a line is adhered to the housing of the sound generating component 100, and the line is pulled for a displacement of, for example, 3.8 mm to 5.5 mm for measurement.

As shown in FIG. 29, using an adhesive (e.g., instant glue, hot melt adhesive, etc.) or other fixing manners that do not damage the structure of the earphone 1, an auxiliary plate 603 and an angle bracket 601 are fixed in the X direction (no relative displacement in the X direction), the auxiliary plate 604 and the angle bracket 602 are fixed in the X direction (no displacement in the X direction), and the auxiliary plate 603 and the auxiliary plate 604 are placed on a support platform (e.g., a lubricant interface or a support platform on a bearing support) with a small coefficient of friction in the X direction. The inner side of the angle bracket 601 in the Y direction and the inner side of the angle bracket 602 in the Y direction are respectively tangent to the two sides of the earphone 1 near the two ends of the ear hook 300, thereby fixing the earphone 1 between the angle bracket 601 and the angle bracket 602. A dynamometer 607 is connected to the angle bracket 602 in the X direction, for example, by fixing the dynamometer 607 and the angle bracket 602 with a screw 606. In some embodiments, the earphone 1 may be further fixed using an adhesive (e.g., instant glue, hot melt adhesive, etc.) or other fixing manners that do not damage the structure of the earphone 1, so that the connection positions between the earphone 1 and the two angle brackets 601, 602 are close to the horizontal direction. For example, as shown in FIG. 29, one side of the sound generating component 100 is fixedly connected to the angle bracket 601 at position A, and one side of the abutting component 400 is fixedly connected to the angle bracket 602 at position B. A line connecting position A and position B is approximately parallel to the X direction. During measurement, the auxiliary plate 604 is fixed. The auxiliary plate 603 is moved by a pulling force in the X direction to increase the distance between the sound generating component 100 and the abutting component 400. The magnitude of the pulling force is obtained by the dynamometer 607, and a distance between the auxiliary plate 603 and the auxiliary plate 604, i.e., the increased distance between the sound generating component 100 and the abutting component 400, is obtained by a vernier caliper.

As shown in FIG. 30, the abutting component 400 is fixed between two clamping plates by a fastener 608. One end of a measuring line 612 is connected to the housing of the sound generating component 100 on the side away from the abutting component 400 using an adhesive (e.g., instant glue, hot-melt adhesive, or the like). For example, the measuring line 612 is connected to the sound generating component 100 at position C, and the symmetry plane SF of the ear hook 300 may pass through position C. The other end of the measuring line 612 is connected to a dynamometer 614. The measuring line 612 is parallel to the X direction. During measurement, the dynamometer 614 is moved by a pulling force in the X direction, thereby pulling the sound generating component 1 to move and increasing the distance between the sound generating component 100 and the abutting component 400. The increased distance between the sound generating component 100 and the abutting component 400 is obtained by a vernier caliper 609, and the magnitude of the pulling force is obtained by the dynamometer 614.

Optionally, the preload force is set to be in a range of 1 gram-force to 25 grams-force, and the elastic coefficient of the ear hook 300 is set such that the elastic force is in a range of 25 grams-force to 48 grams-force when the minimum spacing is 3.85 mm, and the elastic force is in a range of 26 grams-force to 65 grams-force when the minimum spacing is 5.5 mm. Optionally, a width of the ear hook 300 may be in a range of 3 mm to 10 mm, and a thickness of the ear hook 300 may be in a range of 0.5 mm to 5 mm. By reasonably setting the width and thickness parameters of the ear hook 300, the elastic force changes substantially linearly under usage conditions, and effectively improves the wearing comfort, adaptability, stability, and reliability of the earphone 1 while satisfying the clamping stability.

Optionally, as shown in FIG. 26, the earphone 1 may further include a magnetic coupling matching structure 50. The magnetic coupling matching structure 50 provides a magnetic coupling force between the sound generating component 100 and the abutting component 400. The magnetic coupling force and the elastic force cooperate to form the clamping force F. A variation trend of the magnetic coupling force with the minimum spacing between the sound generating component 100 and the abutting component 400 is opposite to a variation trend of the elastic force with the minimum spacing. For example, when the minimum spacing between the sound generating component 100 and the abutting component 400 gradually increases, the elastic force gradually increases, and the magnetic coupling force gradually decreases. The magnetic coupling force provided by the magnetic coupling matching structure 50 may be used for the case where the ear hook 300 causes the sound generating component 100 and the abutting component 400 to abut against each other in the natural state, and may also be used for the case where the ear hook 300 is configured to cause the sound generating component 100 and the abutting component 400 to be separated from each other in the natural state.

By providing the magnetic coupling matching structure 50 to provide the magnetic coupling force, the magnetic coupling force can cooperate with the elastic force to provide a more suitable clamping force F in the wearing state, and can effectively reduce the variation and fluctuation of the clamping force F when the minimum spacing changes. This effectively improves wearing comfort, reduces the preload force required from the ear hook 300, and makes the wearing process of the user smoother.

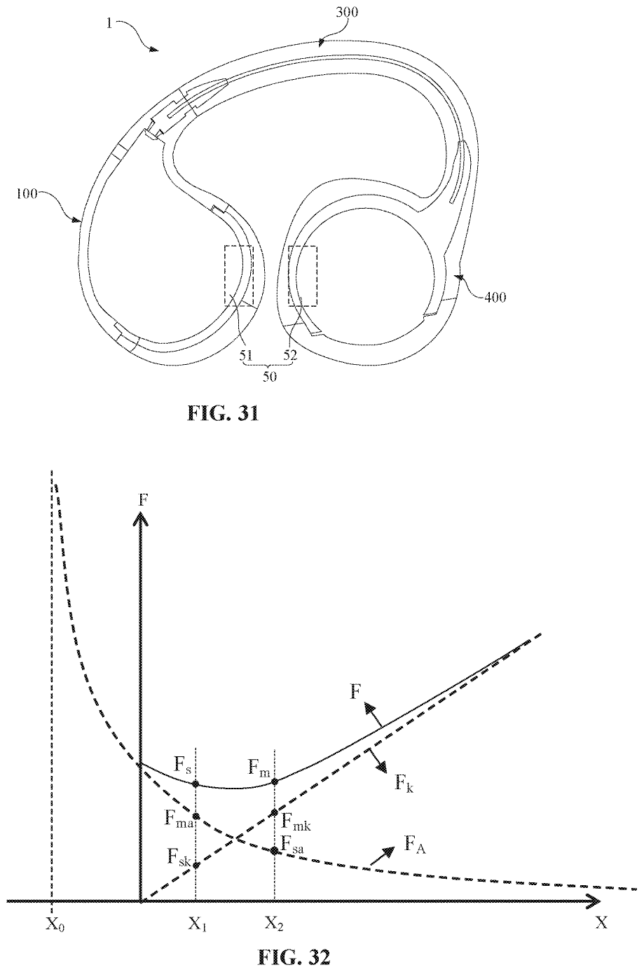

Optionally, as shown in FIG. 31, the magnetic coupling matching structure 50 includes a first magnetic coupling matching member 51 disposed on the sound generating component 100 and a second magnetic coupling matching member 52 disposed on the abutting component 400. The first magnetic coupling matching member 51 and the second magnetic coupling matching member 52 are magnetically attracted to each other. The first magnetic coupling matching member 51 and the second magnetic coupling matching member 52 may be magnets. The first magnetic coupling matching member on the sound generating component 100 may be the magnet 242 of the speaker 21, or may be an additionally provided magnet or any other magnetic member. By respectively disposing the first magnetic coupling matching member 51 and the second magnetic coupling matching member 52 on the sound generating component 100 and the abutting component 400, the magnetic attraction between the first magnetic coupling matching member 51 and the second magnetic coupling matching member 52 is utilized to provide the magnetic coupling force, thereby maintaining a clamping force that has little fluctuation and is moderate in magnitude when clamping the EAR with either a relatively large or small thickness, and effectively improving the wearing comfort. Optionally, the magnets may be arranged in a Halbach array to increase the provided magnetic force, which is beneficial for improving wearing stability. Optionally, the magnet is disposed in the first flexible body 14 to avoid interference with other components and to improve the integration and compactness of the structure of the earphone 1.

In the wearing state, an attractive force between the first magnetic coupling matching member 51 and the second magnetic coupling matching member 52 may compensate for the clamping force F between the sound generating component 100 and the abutting component 400. As shown in FIG. 31, the first magnetic coupling matching member 51 and the second magnetic coupling matching member 52 may attract each other, generating an attractive force F_{A} to compensate for the clamping force F provided by the ear hook 300 for the sound generating component 100 and the abutting component 400. That is, in the wearing state, the clamping force F includes the attractive force F_{A} and the elastic force Fₖ generated by elastic deformation of the ear hook 300. In some embodiments, a relationship between the attractive force and a distance between a first magnetic coupling matching member 51 and a second magnetic coupling matching member 52 may be represented by formula (3):

$${F}_{A} = K \frac{{m}_{1} * {m}_{2}}{{d}^{2}} = K \frac{{m}_{1} * {m}_{2}}{{( x + {X}_{0} )}^{2}} , \qquad ( 3 )$$

where K denotes a constant, m₁ denotes a magnetic moment of the first magnetic coupling matching member 51, m₂ denotes a magnetic moment of the second magnetic coupling matching member 52, d denotes a distance between the first magnetic coupling matching member 51 and the second magnetic coupling matching member 52, X₀ denotes a distance between the first magnetic coupling matching member 51 and the second magnetic coupling matching member 52 in a non-wearing state, and x denotes an increased distance between the first magnetic coupling matching member 51 and the second magnetic coupling matching member 52 due to a movement of the sound generating component 100 and the abutting component 400 in the wearing state.

As can be seen from formula (3), a larger increase x in the distance between the sound generating component 100 and the abutting component 400 results in a correspondingly larger distance d between the first magnetic coupling matching member 51 and the second magnetic coupling matching member 52, and a correspondingly smaller attractive force F_{A} between the first magnetic coupling matching member 51 and the second magnetic coupling matching member 52.

In some embodiments, a dynamometer and spacers of different thicknesses (e.g., silicone pads, thick paper sheets, rubber pads, etc.) may be used to measure different attractive forces corresponding to different distances between the first magnetic coupling matching member 51 and the second magnetic coupling matching member 52. For example, the ear hook 300 of the earphone 1 may be cut off, then any one of the sound generating component 100 or the abutting component 400 is fixed, and the other one of the sound generating component 100 and the abutting component 400 is connected to the dynamometer. The sound generating component 100, the abutting component 400, and the dynamometer may be generally referred to FIG. 29 and FIG. 30. Spacers of different thicknesses are placed between the sound generating component 100 and the abutting component 400 to control the distance between the first magnetic coupling matching member 51 and the second magnetic coupling matching member 52, while the dynamometer measures the attractive force between the first magnetic coupling matching member 51 and the second magnetic coupling matching member 52 when spacers of different thicknesses are placed. In some embodiments, the attractive force may be measured by a thin-film pressure sensor. Specifically, after cutting the ear hook 300 off, the thin-film pressure sensor and spacers of different thicknesses are placed between the sound generating component 100 and the abutting component 400, such that the thin-film pressure sensor is compressed by the attractive force between the first magnetic coupling matching member 51 in the sound generating component 100 and the second magnetic coupling matching member 52 in the abutting component 400, thereby measuring the attractive forces corresponding to different distances between the first magnetic coupling matching member 51 and the second magnetic coupling matching member 52.

In some embodiments, in the non-wearing state, the ear hook 300 may provide a preload force F₀ to cause the sound generating component 100 and the abutting component 400 to abut against each other. The detailed description of the preload force may be found in the relevant descriptions above, which will not be repeated here.

In some embodiments, in the non-wearing state, the sound generating component 100 and the abutting component 400 are not in contact. In the non-wearing state, the sound generating component 100 and the abutting component 400 are not in contact, that is, there is no preload force between the sound generating component 100 and the abutting component 400 to cause them to abut against each other.

In some embodiments, in the wearing state, the clamping force F between the sound generating component 100 and the abutting component 400 includes the elastic force Fₖ generated by elastic deformation of the ear hook 300 and the attractive force F_{A} between the first magnetic coupling matching member 51 and the second magnetic coupling matching member 52. In some embodiments, the clamping force F may further include the preload force F₀ provided by the ear hook 300 for causing the sound generating component 100 and the abutting component 400 to abut against each other.

As can be seen from the foregoing, to ensure the stability of the earphone 1 worn on the ear of the wearer, the clamping force F (i.e., a sum of the elastic force and the attractive force, or a sum of the elastic force, the attractive force, and the preload force) needs to be greater than a lower limit of the clamping force corresponding to a minimum auricle thickness. Furthermore, it is necessary to ensure that the clamping force is less than an upper limit of the clamping force corresponding to a maximum auricle thickness, so as to avoid discomfort for users with larger auricle thickness when wearing the ear-clip earphone. In some embodiments, when a distance between a housing of the sound generating component 100 and the abutting component 400 is in a range of 3.5 mm to 5.6 mm or in a range of 3.8 mm to 5.5 mm, the clamping force F (i.e., the sum of the elastic force and the attractive force, or the sum of the elastic force, the attractive force, and the preload force) may be in a range of 0.20 N to 0.70 N. For example, based on the lower limit of the clamping force 0.20 N corresponding to the minimum auricle thickness and the upper limit of the clamping force 0.70 N corresponding to the maximum auricle thickness, it may be determined that the clamping force provided by the ear hook 300 (i.e., the sum of the elastic force and the attractive force, or the sum of the elastic force, the attractive force, and the preload force) is in a range of 0.20 N to 0.70 N. In some embodiments, when the distance between the housing of the sound generating component 100 and the abutting component 400 is in a range of 3.8 mm to 5.5 mm, the clamping force F (i.e., the sum of the elastic force and the attractive force, or the sum of the elastic force, the attractive force, and the preload force) may be in a range of 0.25 N to 0.65 N. As another example, based on the lower limit of the clamping force 0.25 N corresponding to the minimum auricle thickness and the upper limit of the clamping force 0.65 N corresponding to the maximum auricle thickness, it may be determined that the clamping force provided by the ear hook 300 (i.e., the sum of the elastic force and the attractive force, or the sum of the elastic force, the attractive force, and the preload force) is in a range of 0.25 N to 0.65 N.

As can be seen from the foregoing, the larger the distance x between the sound generating component 100 and the abutting component 400, the larger the elastic force Fₖ provided by the ear hook 300 and the smaller the attractive force F_{A} between the first magnetic coupling matching member 51 and the second magnetic coupling matching member 52. Therefore, a difference between the clamping force F experienced by a user with small ears and the clamping force F experienced by a user with large ears can be further reduced based on the attractive force between the first magnetic coupling matching member 51 and the second magnetic coupling matching member 52. For example, by limiting the clamping force F to be in a range of 0.3 N to 0.5 N, the difference between the clamping force experienced by the user with small ears and the clamping force experienced by the user with large ears is reduced to 0.20 N. In some embodiments, when the distance between the housing of the sound generating component 100 and the abutting component 400 is in a range of 3.8 mm to 5.5 mm, a change of the clamping force F does not exceed 0.20 N. Thus, as shown in FIG. 27, to ensure a small difference between the clamping force experienced by the user with small ears and the clamping force experienced by the user with large ears, based on a minimum auricle thickness Xₛ, a set lower limit of the clamping force F₁, a maximum auricle thickness Xₘ, and a set upper limit of the clamping force F₃, it may be specified that when the distance between the sound generating component 100 and the abutting component 400 changes between 3.8 mm and 5.5 mm, the change of the clamping force, for example, does not exceed 0.20 N (i.e., the difference between F₃ and F₁).

In some embodiments, when the distance between the sound generating component 100 and the abutting component 400 is in a range of 3.8 mm to 5.5 mm, a change of the attractive force between the first magnetic coupling matching member 51 and the second magnetic coupling matching member 52 may be in a range of 0.05 N to 0.10 N.

As shown in FIG. 32, the clamping force F includes the elastic force Fₖ and the attractive force F_{A}. An initial distance between the first magnetic coupling matching member 51 and the second magnetic coupling matching member 52 is X₀. The elastic force Fₖ is equal to kX, where k is an elastic coefficient, and X is the distance between the sound generating component 100 and the abutting component 400. The attractive force F_{A} may be determined based on formula (3) described above. When the distance between the sound generating component 100 and the abutting component 400 is in a range of X₁ to X₂, the elastic force Fₖ is in a range of Fₛₖ to Fₘₖ, the attractive force F_{A} is in a range of Fₘₐ to Fₛₐ, and the clamping force F is in a range of Fₛ to Fₘ, where Fₛ=Fₘₐ+Fₛₖ, and Fₘ=Fₘₖ+Fₛₐ. For example, when the distance between the sound generating component 100 and the abutting component 400 is in a range of 3.8 mm to 5.5 mm, the corresponding elastic force is in a range of 0.27 N to 0.35 N. To ensure the clamping force in a range of 0.3 N to 0.4 N, the compensating attractive force needs to be in a range of 0.03 N (0.3−0.27=0.03) to 0.05 N (0.4−0.35=0.05). As can be seen from FIG. 13A, by setting appropriate magnetic coupling parameters (K, m1, m2, X₀, etc.) and the elastic coefficient k, etc., an increment of Fₖ and a decrement of F_{A} may be substantially or mostly offset within the range of X₁ to X₂, causing the total clamping force F to remain substantially stable within the range of X₁ to X₂, thereby providing a consistent user experience for users with different auricle thicknesses when using the earphone 1. The range of X₁ to X₂ includes, for example, 3.8 mm to 5.5 mm.

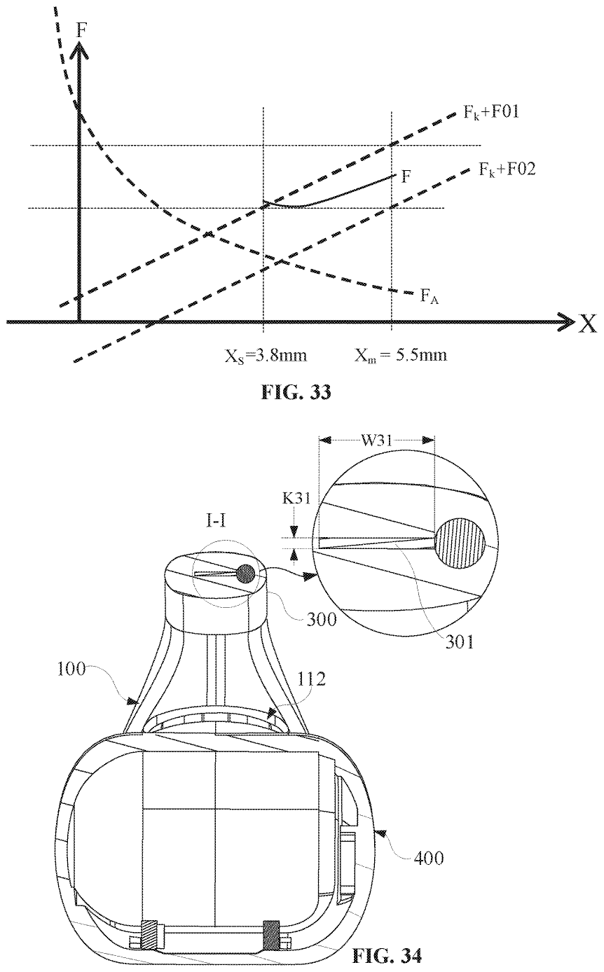

In some embodiments, the ear hook 300 further provides the preload force F₀. The magnitude of the total clamping force F may be maintained within a suitable range by adjusting the magnitudes of the preload force F₀ and the attractive force F_{A}. As shown in FIG. 33, the ear hook 300 may simultaneously provide the elastic force Fₖ, the preload force F₀, and the attractive force F_{A}. In this case, the clamping force F applied by the ear hook 300 to the user with large ears has exceeded an upper limit of the preload force. By reducing the preload force F₀ from F₀₁ to F₀₂, the curve corresponding to the clamping force F within the range from the minimum auricle thickness Xₛ to the maximum auricle thickness Xₘ becomes relatively flat and falls within a suitable clamping force range. This indicates that the cooperation between the preload force and the attractive force may improve the wearing stability and comfort of the ear-clip earphone and reduce the difference in clamping force between the user with large ears and the user with small ears.

Optionally, the elastic force and the magnetic coupling force are set such that when the minimum spacing between the sound generating component 100 and the abutting component 400 increases from 3.85 mm to 5.5 mm, the clamping force is in a range of 25 grams-force to 65 grams-force, for example, the clamping force may be 30 grams-force, 40 grams-force, 50 grams-force, 60 grams-force, etc. It should be noted that 1 gram-force represents the gravitational force on a 1-gram object.

By reasonably setting the elastic force and the magnetic coupling force, a consistent clamping force is provided for users with different ear sizes in the wearing state, improving wearing comfort while ensuring wearing stability.

Optionally, the magnetic coupling force is set such that when the minimum spacing between the sound generating component 100 and the abutting component 400 increases from 3.8 mm to 5.5 mm, a change of the magnetic coupling force is greater than or equal to 20 grams-force. Such a setting allows the change of the magnetic coupling force to be relatively large, so the change of the elastic force may be relatively small. Consequently, the elastic coefficient of the ear hook 300 may be set relatively small, which is beneficial for improving the stability and reliability of wearing the earphone 1.

Optionally, as shown in FIG. 34, the ear hook 300 includes an elastic sheet 301. Two ends of the elastic sheet 301 along a length direction of the elastic sheet 301 are respectively fixed relative to the sound generating component 100 and the abutting component 400. A ratio of a width W31 of the elastic sheet 301 to a thickness K31 of the elastic sheet 301 is in a range of 8 to 12, for example, the ratio may be 9, 10, 11, etc. In some embodiments, the width W31 of the elastic sheet 301 is in a range of 1 mm to 3 mm, for example, the width W31 may be 2 mm. The thickness K31 is in a range of 0.1 mm to 0.3 mm, for example, the thickness K31 may be 0.15 mm, 0.2 mm, 0.25 mm, etc.

By providing the elastic sheet 301 to supply the elastic force, clip-on wearing of the earphone 1 is achieved. By reasonably setting the ratio of the width to the thickness, sufficient strength of the ear hook 300 is ensured while meeting the requirement for the elastic force, allowing the earphone 1 to have both wearing comfort and wearing stability. Furthermore, reasonably setting the width and thickness of the elastic sheet 301 can reduce torque on the elastic sheet 301, prevent torsion, and make the change of the provided elastic force more linear, effectively improving wearing comfort. The elastic sheet 301 may be, for example, a titanium sheet. The exterior of the elastic sheet 301 is coated with a flexible material, such as silicone, rubber, elastic resin, polyurethane material, polydimethylsiloxane, PVC, TPE, etc., to improve wearing comfort.

Optionally, the earphone 1 further includes a flexible printed circuit board (FPC). The flexible printed circuit board is arranged along the length direction of the elastic sheet 301 and disposed on the elastic sheet 301. Based on this, wiring difficulty on the earphone 1 can be effectively reduced. Merely by way of example, the FPC may be disposed to extend substantially along an upper surface or a lower surface of the elastic sheet 301. Two ends of the elastic sheet 301 may be provided with plug-in blocks 2332. The plug-in blocks 2332 at the two ends may be respectively plug-connected to the sound generating component 100 and the abutting component 400. The elastic sheet 301 is provided with a notch 2330 at a position close to the plug-in block 2332. The notch 2330 penetrates in a width direction to a side edge of the elastic sheet 301. The notch 2330 facilitates sealing with an adhesive, resulting in a better injection molding effect.

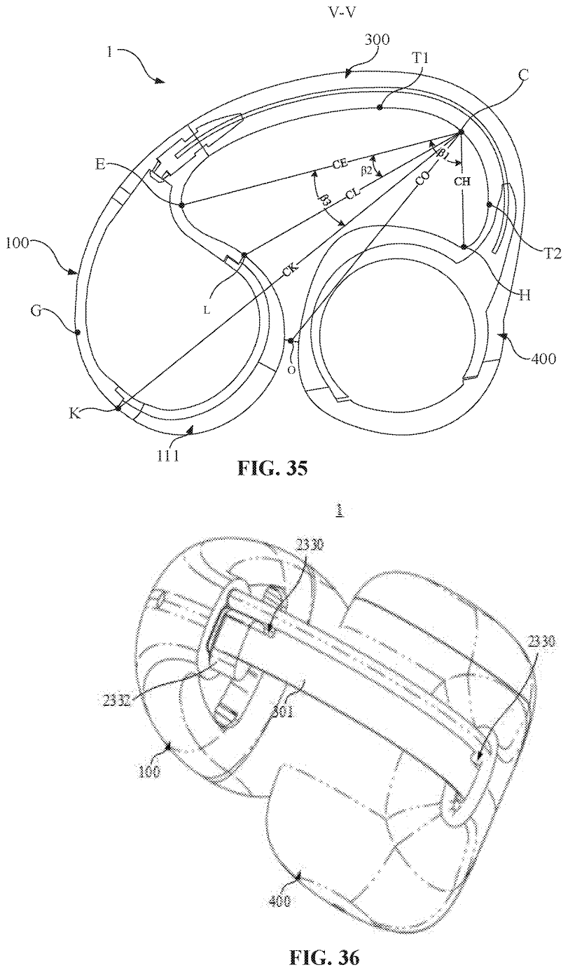

Optionally, as shown in FIG. 35, the earphone 1 has the reference cross-section SF. The reference cross-section is arranged along a length direction of the ear hook 300. In a wearing state, the reference cross-section is nearly parallel to a horizontal plane of a human body. Within the reference cross-section, the ear hook 300, the sound generating component 100, and the abutting component 400 have an inner contour. The inner contour includes at least a reference point C, a reference point E, and a reference point H.

In the wearing state, the reference point C is a reference point located on the inner contour of the ear hook 300 and corresponding to an edge of a helix (e.g., a topmost/outermost edge of the helix). The reference point C may be an inflection point of the inner contour. Merely by way of example, the inner contour 300 is a contour line that protrudes entirely away from the helix E17. A curvature radius of a portion of the inner contour 300 located near the edge of the helix first increases, then decreases, and then increases again along a direction starting from the reference point C and extending toward the sound generating component 300 and the abutting component 400, respectively.

In some embodiments, in the natural state, an outer wall surface of a sound generating component 210 and an outer wall surface of the abutting component 400 do not abut against each other. There is a position where a distance between the outer wall surface of the sound generating component 100 and the outer wall surface of the abutting component 400 is shortest. A midpoint of a line connecting the positions corresponding to the shortest distance between the outer wall surface of the sound generating component 100 and the outer wall surface of the abutting component 400 is a point O. In the natural state, if the outer wall surface of the sound generating component 210 and the outer wall surface of the abutting component 400 abut against each other, a length of a shortest connecting line between the outer wall surface of the sound generating component 210 and the outer wall surface of the abutting component 400 is nearly 0. In this case, the reference point O should be a midpoint of an arc formed by a contact region where the outer wall surface of the sound generating component 210 abuts against the outer wall surface of the abutting component 400. The reference point C is a reference point on the inner contour that has a greatest distance from the point O. A reference point L is a point on the sound generating component 100 that is closest to the reference point C. A reference point K is a point on the sound generating component 100 that is farthest from the reference point C.

Optionally, as shown in FIG. 35, a connecting line CE is formed between the reference point C and the reference point E. A connecting line CH is formed between the reference point C and the reference point H. In the natural state, a length of the connecting line CE is in a range of 16 mm to 19 mm. A length of the connecting line CH is in a range of 6.5 mm to 9.0 mm. An included angle between the connecting line CE and the connecting line CH is in a range of 72° to 88°. The inner contour between the reference point C and the reference point E is located outside the connecting line CE. The inner contour between the reference point C and the reference point H is located outside the connecting line CH.

In the experience of using the ear-clip earphone 1, if the inner contour of the earphone 1 contacts the helix, it may significantly affect the wearing comfort of the earphone 1 during long-term use and impact the user experience.

If the included angle between the connecting line CE and the connecting line CH is too small, the inner contour of the earphone 1, especially the inner contour between the reference point C and the reference point E, and the inner contour between the reference point C and the reference point H, cannot bypass the helix as much as possible. If the included angle is too large, it increases the overall structural size of the earphone 1, affecting the overall aesthetics of the earphone 1. Therefore, setting the included angle between the connecting line CE and the connecting line CH within the range of 72° to 88° can ensure that the inner contour of the earphone 1 can bypass the helix as much as possible, reducing contact between the inner contour of the earphone 1 and the helix, thereby effectively improving the wearing comfort and aesthetics of the earphone 1. Merely by way of example, in some embodiments, the included angle between the connecting line CE and the connecting line CH may be set to 80°.

Furthermore, if the length of the connecting line CE is too small, the sound generating component 100 may not extend into the concha cavity, affecting the sound quality of the earphone 1, or the sound generating component 100 may extend into the concha cavity but the inner contour of the earphone 1, especially the position at the reference point C, may contact the helix. If the length is too large, it increases the overall structural size of the earphone 1, affecting the aesthetics of the earphone 1. Therefore, setting the length of the connecting line CE within the range of 16 mm to 19 mm ensures that the sound generating component 100 stably extends into the concha cavity while ensuring that the inner contour and the sound generating component 100 do not contact the helix E17, thereby effectively improving the wearing comfort and aesthetics of the earphone 1200 while effectively enhancing the sound transmission quality of the earphone 1. Furthermore, if the length of the connecting line CH is too small, the abutting component 400 may contact the helix. If the length is too large, it increases the overall structural size of the earphone 1, affecting aesthetics of the earphone 1. Therefore, setting the length of the connecting line CH within the range of 6.5 mm to 9.0 mm better ensures that the inner contour of the earphone 1 can bypass the helix as much as possible, ensuring that the inner contour and the abutting component 400 of the earphone 1 do not contact the helix, thereby effectively improving the wearing comfort of the earphone 1. Merely by way of example, in some embodiments, the length of the connecting line CE is set to 17.13 mm, and the length of the connecting line CH is set to 7.59 mm.

Optionally, an arc-to-chord ratio of the inner contour between the reference point C and the reference point E is in a range of 1.02 to 1.20. Optionally, an arc-to-chord ratio of the inner contour between the reference point C and a third reference point His in a range of 1.05 to 1.23.

Specifically, the arc-to-chord ratio of the inner contour between the reference point C and the reference point H specifically refers to a ratio of an actual length of the inner contour between the reference point C and the reference point H to a length of the connecting line CE. Merely by way of example, in some embodiments, the inner contour is a curved arc contour. The arc-to-chord ratio of the inner contour between the reference point C and the reference point E is a ratio of an arc length of the inner contour between the reference point C and the reference point E to the length of the connecting line CE. It is worth noting that, in this embodiment, the inner contour between the reference point C and the reference point E is a continuous arc protruding away from the connecting line CE. In other embodiments, the inner contour may not be set as a curve; it may also be a polyline composed of a plurality of segments, etc.

If the arc-to-chord ratio of the inner contour between the reference point C and the reference point E is too small, the inner contour between the reference point C and the reference point E becomes relatively straight, which is not conducive to bypassing the helix. If the arc-to-chord ratio of the inner contour between the reference point C and the reference point E is too large, it causes the inner contour between the reference point C and the reference point E to be overly curved, affecting the overall aesthetics of the earphone 1. Therefore, setting the arc-to-chord ratio of the inner contour between the reference point C and the reference point E within the range of 1.02 to 1.20 allows the inner contour between the reference point C and the reference point E to bypass the helix as much as possible without contacting the helix, thereby effectively improving the wearing comfort of the earphone 1 while also effectively enhancing the aesthetics of the earphone 10. Merely by way of example, in some embodiments, the arc-to-chord ratio between the reference point C and the reference point E may be set to 1.1.

Optionally, between the reference point L and the reference point K and on a side facing the abutting component 400, an arc-to-chord ratio of an outer wall surface of the sound generating component 100 is in a range of 1.4 to 1.7. Based on this configuration, the side of the sound generating component 100 facing the abutting component 400 tends more towards a spherical shape. Between the reference point L and the reference point K and on the side facing the abutting component 400, the outer wall surface of the sound generating component 100 is a continuous curved surface protruding toward the side of the abutting component 400. Merely by way of example, in some embodiments, between the reference point L and the reference point K and on the side facing the abutting component 400, the arc-to-chord ratio of the outer wall surface of the sound generating component 100 may be set to 1.64.

Optionally, a connecting line CL is formed between the reference point C and the reference point L. The connecting line CL is located between the connecting line CE and the connecting line CH. A length of the connecting line CL is in a range of 13 mm to 17 mm. An included angle between the connecting line CL and the connecting line CE is in a range of 15° to 27°.

Specifically, the reference point L is a special point on the sound generating component 100 that is closest to the reference point C. Therefore, the included angle between the connecting line CL and the connecting line CE to some extent determines whether the sound generating component 100 can be fully placed within the concha cavity. The length of the connecting line CL to some extent determines whether the inner contour of the earphone 1 can avoid contact with the helix while the sound generating component 100 is fully placed within the concha cavity 1. Therefore, setting the length of the connecting line CL in a range of 13 mm to 17 mm and setting the included angle between the connecting line CL and the connecting line CE in a range of 15° to 27° allows the sound generating component 100 to be fully placed within the concha cavity under the premise that the inner contour does not contact or press against the helix, thereby effectively improving the wearing comfort of the earphone 1 while also effectively enhancing the sound transmission quality of the earphone 1. Merely by way of example, in some embodiments, a length of a third connecting line is set to 15 mm, and the included angle between the connecting line CL and the connecting line CE is set to 21°.

Optionally, a connecting line CK is formed between the reference point C and the reference point K. The connecting line CK is located between the connecting line CE and the connecting line CH. A length of the connecting line CK is in a range of 24 mm to 30 mm. An included angle between the connecting line CK and the connecting line CE is in a range of 13° to 25°

When the earphone 1 is in the wearing state, the reference point K is closest to the earhole. If the reference point K is too close to the earhole, it may block the earhole, affecting the user experience. If the reference point K is too far from the earhole, it may affect the sound transmission effect of the earphone 1. Therefore, setting the length of the connecting line CK within the range of 24 mm to 30 mm and setting the included angle between the connecting line CK and the connecting line CE within the range of 13° to 25° allows a region of the sound generating component 100 near the reference point K to maintain a relatively moderate distance from the earhole when the sound generating component 100 extends into the concha cavity, thereby effectively preventing the sound generating component 100 from blocking the earhole while effectively improving the sound transmission effect of the earphone 1. Merely by way of example, in some embodiments, the length of the connecting line CK may be set to 27.7 mm, and the included angle between the connecting line CK and the connecting line CE may be set to 20°

Optionally, as shown in FIG. 35, along the inner contour, an arc segment T1T2 is defined between two points located on respective sides of the reference point C and each being 6 mm away from the reference point C. An arc-to-chord ratio of the arc segment T1T2 is in a range of 1.03 to 1.10. This configuration can effectively reduce stress concentration, effectively improve the service life and reliability of the ear hook 300, and is beneficial for ensuring the wearing stability of the earphone 300.

The foregoing descriptions are merely partial embodiments of the present application and are not intended to limit the scope of the present application. Any equivalent device or equivalent process transformation made based on the content of the specification and drawings of the present application, or direct or indirect application in other related technical fields, shall similarly fall within the patent protection scope of the present application.

What is claimed is:

1. An earphone, comprising: a sound generating component, an abutting component, and an ear hook; wherein
the ear hook connects the sound generating component and the abutting component;
the sound generating component is configured to covert an electrical signal into an acoustic signal and play the acoustic signal;
a battery is disposed within the abutting component;
in a wearing state, the sound generating component and the abutting component form a clamping state on two sides of a helix of a user, and the sound generating component is located in a concha cavity;
the sound generating component includes a first housing and a sound generating assembly, and the first housing is configured to form a first accommodating cavity;
the sound generating assembly is disposed in the first accommodating cavity;
the first housing is provided with a sound outlet hole;
a sound generated by the sound generating assembly is output through the sound outlet hole;
the sound outlet hole is arranged in a strip shape and has a first end and a second end spaced apart along a length direction of the sound outlet hole; and
in the wearing state, the first end is oriented toward an ear hole, and a distance between an outer wall surface of the first housing at the second end and an inner wall surface of the concha cavity is less than a distance between the outer wall surface of the first housing at the first end and the inner wall surface of the concha cavity.

2. The earphone according to claim 1, wherein at the second end and/or on a side of the second end away from the first end, the outer wall surface of the first housing and the inner wall surface of the concha cavity are in contact with each other.

3. The earphone according to claim 2, wherein
the outer wall surface of the first housing is configured such that a long edge of the sound outlet hole is arranged in an arc shape, and
a distance between the outer wall surface of the first housing and the inner wall surface of the concha cavity gradually increases in a direction from the second end to the first end.

4. The earphone according to claim 2, wherein an arc-to-chord ratio of the long edge of the sound outlet hole is in a range of 1.05-1.4, or is greater than or equal to 1.02 and less than 1.05.

5. The earphone according to claim 3, wherein an aspect ratio of the sound outlet hole is in a range of 0.15-0.30.

6. The earphone according to claim 3, wherein a length of the sound outlet hole is in a range of 9 mm-16.5 mm, or is greater than or equal to 5 mm and less than 9 mm.

7. The earphone according to claim 3, wherein
when the sound generating component and the abutting component are simultaneously placed on a horizontal reference plane, the long edge of the sound outlet hole forms a first reference point between the first end and the second end with the horizontal reference plane;
the second end is located on a side of the first reference point toward the abutting component; and
the first end is located on a side of the first reference point away from the abutting component.

8. The earphone according to claim 7, wherein
a length of the long edge of the sound outlet hole between the first end and the first reference point is in a range of 2 mm-5.5 mm, and
a length of the long edge of the sound outlet hole between the second end and the first reference point is in a range of 4.5 mm-8 mm.

9. The earphone according to claim 8, wherein
an arc-to-chord ratio of the long edge of the sound outlet hole between the first end and the first reference point is in a range of 1.02-1.05, or is greater than or equal to 1.001 and less than 1.02, and
an arc-to-chord ratio of the long edge of the sound outlet hole between the second end and the first reference point is in a range of 1.02-1.05, or is greater than 1.05 and less than or equal to 1.07.

10. The earphone according to claim 8, wherein
the long edge of the sound outlet hole has a first normal direction at the first reference point, a second normal direction at the first end, and a third normal direction at the second end,
an included angle between the first normal direction and the second normal direction is in a range of 30°-42°, or is greater than or equal to 15° and less than 30°, and
an included angle between the first normal direction and the third normal direction is in a range of 50°-60°, or is greater than or equal to 25° and less than 50°.

11. The earphone according to claim 3, wherein
the sound outlet hole has a median line along the length direction of the sound outlet hole;
the sound outlet hole intersects with a reference cross-section along a length direction of the ear hook;
an included angle between a plane where the median line lies and the reference cross-section is in a range of 0°-45°; and
the sound outlet hole is offset toward an earlobe direction.

12. The earphone according to claim 11, wherein
the plane where the median line lies and the reference cross-section coincide with each other; or
the sound outlet hole is mirror-symmetric with respect to the reference cross-section.

13. The earphone according to claim 11, wherein
on the reference cross-section, the sound generating component has a second reference point closest to the abutting component;
an inner contour of the ear hook has a third reference point farthest from the second reference point in a region close to an edge of the helix in the wearing state;
the sound outlet hole is located on a side of the second reference point away from the third reference point; and
on an outer wall surface of the sound generating component, a distance from the second end to the second reference point is in a range of 2.2 mm-4.2 mm, and a distance from the first end to the second reference point is in a range of 9 mm-12.4 mm.

14. The earphone according to claim 11, wherein the sound generating component is further provided with a pressure relief hole, and the pressure relief hole is oriented toward the helix, and the pressure relief hole intersects with the reference cross-section, or is mirror-symmetric with respect to the reference cross-section.

15. The earphone according to claim 14, wherein the pressure relief hole and the sound outlet hole are spaced apart from each other by a contact region between the sound generating component and the concha cavity.

16. The earphone according to claim 15, wherein
a count of pressure relief holes is one,
the pressure relief hole is arranged in a strip shape, and
the reference cross-section is arranged along a width direction of the pressure relief hole and intersects with the pressure relief hole.

17. The earphone according to claim 15, wherein
there are two pressure relief holes, which are respectively disposed on two sides of the reference cross-section, and are mirror-symmetric with respect to the reference cross-section; and
the reference cross-section is disposed along a width direction of any one of the two pressure relief holes.

18. The earphone according to claim 15, wherein
the pressure relief hole includes a first aperture part and a second aperture part along a length direction of the pressure relief hole, and a third aperture part connected between the first aperture part and the second aperture part, and
a width of at least a portion of the first aperture part and the second aperture part is greater than a width of the third aperture part.

19. The earphone according to claim 15, wherein
the sound generating assembly is provided with a sound guiding hole communicating with the pressure relief hole through the first accommodating cavity; and
a distance between the sound guiding hole and the pressure relief hole is not greater than 0.5 mm, or is greater than 0.5 mm and less than or equal to 4 mm.

20. The earphone according to claim 1, wherein
the sound generating assembly includes two loudspeakers;
each of the two loudspeakers includes a diaphragm;
the two loudspeakers are assembled with each other along an axial direction to form a first acoustic cavity between the two loudspeakers;
the sound generating assembly is provided with a first sound guiding hole communicating the sound outlet hole and the first acoustic cavity;
the sound outlet hole and the first sound guiding hole communicate with each other along a radial direction of the sound generating assembly;
the first sound guiding hole is further arranged in a strip shape; and
a length direction of the sound outlet hole and a length direction of the first sound guiding hole are arranged along a circumferential direction of the sound generating assembly.
